(19) United States
(12) Patent Application Publication
(10) Pub. No.: US 2005/0184549 A1
(43) Pub. Date: Aug. 25, 2005

(54) Reversible seat assembly

(76) Inventors: David L. Robinson, Sterling Heights, MI (US); Richard D. Cramb, Livonia, MI (US); Matthew J. Starna, New Baltimore, MI (US); Christopher J. Ryan, Fraser, MI (US); Shihong Yu, Troy, MI (US); Craig C. Hoekstra, Clinton Township, MI (US)

Correspondence Address: HARNESS, DICKEY & PIERCE, P.L.C., P.O. BOX 828, BLOOMFIELD HILLS, MI, 48303, US

(21) Appl. No.: 11/052,211

(22) Filed: Feb. 7, 2005

Related U.S. Application Data
(60) Provisional application No. 60/542,692, filed on Feb. 6, 2004.

(51) Int. Cl. B60N 2/02

(52) U.S. Cl. 296/65.03

(57) ABSTRACT

A seat adjustment mechanism for a vehicle seat having a seat bottom supported by the vehicle and a seatback coupled to the seat bottom includes a floor latch mechanism and a recliner mechanism. The floor latch mechanism is connected to the vehicle seat and pivots the seat bottom relative the vehicle. The recliner mechanism is coupled to the seat bottom and seatback and permits rotation of the seatback relative to the seat bottom when in an unlocked state. The recliner mechanism is automatically toggled into the unlocked state when the floor latch mechanism is released and the seat bottom is rotated a predetermined amount relative to the vehicle. Therefore, the seat adjustment mechanism allows seat bottom and seatback to be articulated into a stowed position through actuation of a single lever or button.

### CROSS-REFERENCE TO RELATED APPLICATIONS

This application claims the benefit of U.S. Provisional Application No. 60/542,692, filed on Feb. 6, 2004. The disclosure of the above application is incorporated herein by reference.

### FIELD OF THE INVENTION

The present invention relates to seat adjustment mechanisms and, more particularly, to seat adjustment mechanism allowing a seat to be articulated into a stowed position.

### BACKGROUND OF THE INVENTION

Reconfigurable seating systems are commonly used in sport utility vehicles and minivans to provide a user with a desired seating configuration. Such seating systems generally allow the user to position each seat within the vehicle in a plurality of positions. For example, most vehicle seats include a recliner mechanism disposed generally between a seatback and a seat bottom to provide selective rotation of the seatback relative to the seat bottom. Rotation of the seatback relative to the seat bottom allows the seatback to be positioned in a plurality of recline positions and may also allow the seatback to be folded flat relative to the seat bottom. In the fold-flat position, the seatback is generally parallel with the seat bottom and, thus, may provide a flat workspace or load floor (i.e., a back surface of the seatback when folded).

In addition to articulation of the seatback relative to the seat bottom, some configurable seating systems also provide for adjustment of both the seat bottom and the seatback relative to the vehicle. In one such arrangement, rotation of the seat bottom and seatback relative to the vehicle is accomplished after the seatback is positioned in the fold-flat position and is generally used to temporarily gain access to an area behind the seatback (i.e., a dump position). Furthermore, such arrangements may also allow the user to articulate the seat forward and stow the seat adjacent to the floor of the vehicle, thereby increasing the ability of the vehicle to carry cargo and the like. In either situation, a floor latch mechanism is typically released once the seatback is in the fold-flat position to thereby allow the seatback and seat bottom to rotate relative to the vehicle.

### SUMMARY OF THE INVENTION

Accordingly, a seat adjustment mechanism for a vehicle seat having a seat bottom supported by the vehicle and a seatback coupled to the seat bottom is provided and includes a floor latch mechanism and a recliner mechanism. The floor latch mechanism is connected to the vehicle seat and pivots the seat bottom relative the vehicle. The recliner mechanism is coupled to the seat bottom and seatback and permits rotation of the seatback relative to the seat bottom when in an unlocked state. The recliner mechanism is automatically toggled into the unlocked state when the floor latch mechanism is released and the seat bottom is rotated a predetermined amount relative to the vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a seat adjustment mechanism in accordance with the present invention;

FIG. 2 is a side view of the seat adjustment mechanism of FIG. 1 in a use position;

FIG. 3. is a side view of the seat adjustment mechanism of FIG. 1 in a partially stowed position;

FIG. 4 is a side view of the seat adjustment mechanism of FIG. 1 in a stowed position;

FIG. 5 is an exploded perspective view of a floor latch assembly of the seat adjustment mechanism of FIG. 1;

FIG. 6 is a side elevational view of the floor latch assembly of the present invention in a latched mode;

FIG. 7 is an upper perspective view of the floor latch assembly of the present invention in its latched mode and with a latch assembly housing plate removed for clarity;

FIG. 8 is a side elevational view of the floor latch assembly of the present invention in an unlatched mode;

FIG. 9 is a perspective view of a vehicle seat pivot assembly of the seat adjustment mechanism of FIG. 1;

FIG. 10A is an exploded perspective view of the vehicle seat pivot assembly of FIG. 9;

FIG. 10B is a perspective view of a locking mechanism of the vehicle seat pivot assembly of FIG. 10A;

FIG. 11 is a side view of the vehicle seat pivot assembly of FIG. 9 illustrating a low load sector plate and low load cam in a seating position;

FIG. 12 is a side view of the vehicle seat pivot assembly of FIG. 11 in a stowed position;

FIG. 13 is a side view of a vehicle seat pivot assembly illustrating a high load sector plate and high load cam in a seating position;

FIG. 14 is a side view of the vehicle seat pivot assembly of FIG. 13 in a stowed position;

FIG. 15 is a side view of a vehicle seat pivot assembly illustrating the position of a stop pin in a seating position;

FIG. 16 is a side view of the vehicle seat pivot assembly of FIG. 15 illustrating the stop pin in a stowed position;

FIG. 17 is a perspective view of a power system for use with the seat adjustment mechanism of FIG. 1;

FIG. 18 is an exploded view of the power system of FIG. 17;

FIG. 19 is a perspective view of an actuation mechanism in accordance with the present teachings;

FIG. 20 is a perspective view of the actuation mechanism of FIG. 19 attached to a seat assembly;

FIG. 21 is a side view of the actuation mechanism of FIG. 19 attached to a seat assembly;

FIG. 22 is a schematic representation of a seat assembly incorporating the actuation mechanism of FIG. 19;

FIG. 23 shows the seat assembly of FIG. 23 in a partially dumped position;

FIG. 24 shows the seat assembly of FIG. 23 in a fully dumped and stowed position;

FIG. 25 is an exploded perspective view of a recliner mechanism associated with the seat adjustment mechanism of FIG. 1;

FIG. 26 is a perspective view of a recliner mechanism in accordance with the principles of the present invention in an engaged position with a cover plate removed to expose a release cam;

FIG. 27 is a perspective view of the recliner mechanism of FIG. 26 in a disengaged position;

FIGS. 28 and 29 are side views of the recliner mechanism of FIG. 26 in the engaged position with a release cam removed; and

FIGS. 30 and 31 are side views of the recliner mechanism of FIG. 26 in the disengaged position.

FIG. 32 is a front perspective view of a headrest assembly of the seat adjustment mechanism of FIG. 1;

FIG. 33 is a rear perspective view of the headrest assembly of FIG. 32;

FIG. 34 is an exploded view of the headrest assembly of FIG. 32;

FIG. 35 is a more detailed exploded view of an automated actuator of FIG. 34;

FIG. 36 is a rear view of the headrest assembly of FIG. 32, with the back plate removed to illustrate the headrest assembly with a lock member in a disengaged position;

FIG. 37 is a rear view of the headrest assembly of FIG. 36, with the back plate removed to illustrate the headrest assembly in a stow position;

FIG. 38 is a rear view of the headrest assembly of FIGS. 36 and 37, with a back plate removed to illustrate the headrest assembly in a use position;

FIG. 39 is a side view of a seat assembly incorporating the headrest assembly of FIG. 32 and with both assemblies in a use position; and

FIG. 40 is a side view of the seat assembly of FIG. 39 with both assemblies in a stow position.

### DETAILED DESCRIPTION

The following description is merely exemplary in nature and is in no way intended to limit the invention, its application, or uses.

With reference to the drawings, a seat adjustment mechanism 10 is provided and includes a seatback frame 12 rotatably supported by a seat bottom frame 14, a front floor mounting assembly 16, a rear floor mounting assembly 18, a recliner assembly 20, and a headrest assembly 22. The seatback frame 12 movable into a dumped position or into one of a plurality of recline positions relative to the seat bottom frame 14 through actuation of the recliner assembly 20.

The front floor mounting assembly 16 and rear floor mounting assembly 18 are disposed generally at fore and aft positions of the seat adjustment mechanism 10, respectively, and selectively permit rotation of the seat bottom frame 14 and seatback frame 12 relative to an external structure (not shown). The headrest assembly 22 is disposed at a top portion of the seatback frame 12, generally opposite the recliner assembly 20, and provides an occupant with head and neck support when the seat adjustment mechanism 10 is in a use position. The headrest assembly 22 is movable relative to the seatback fame 12 into a desired comfort position when the seatback frame 12 is in a use position and into a retracted position when the seatback frame 12 is positioned into the dumped position, as will be described further below.

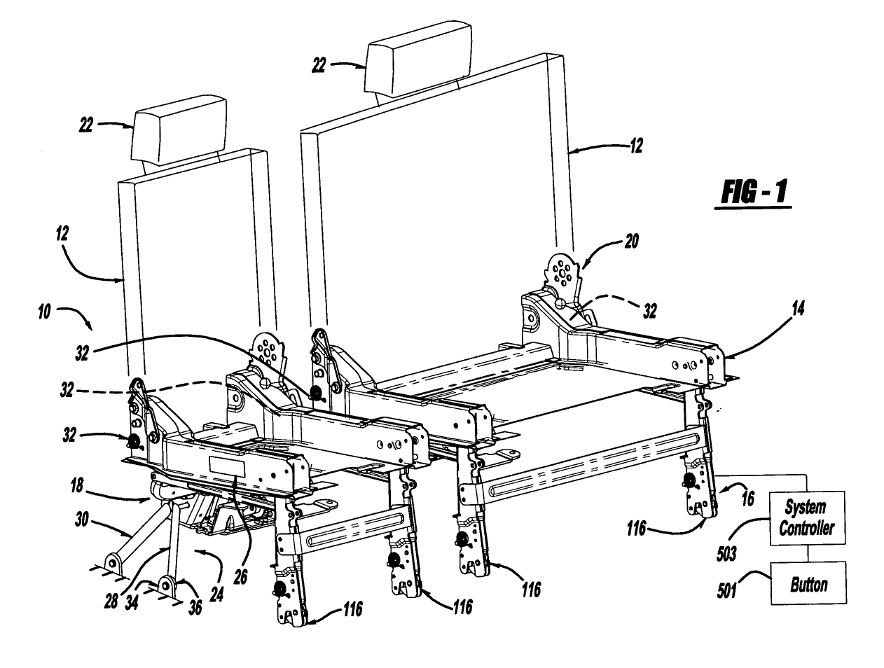

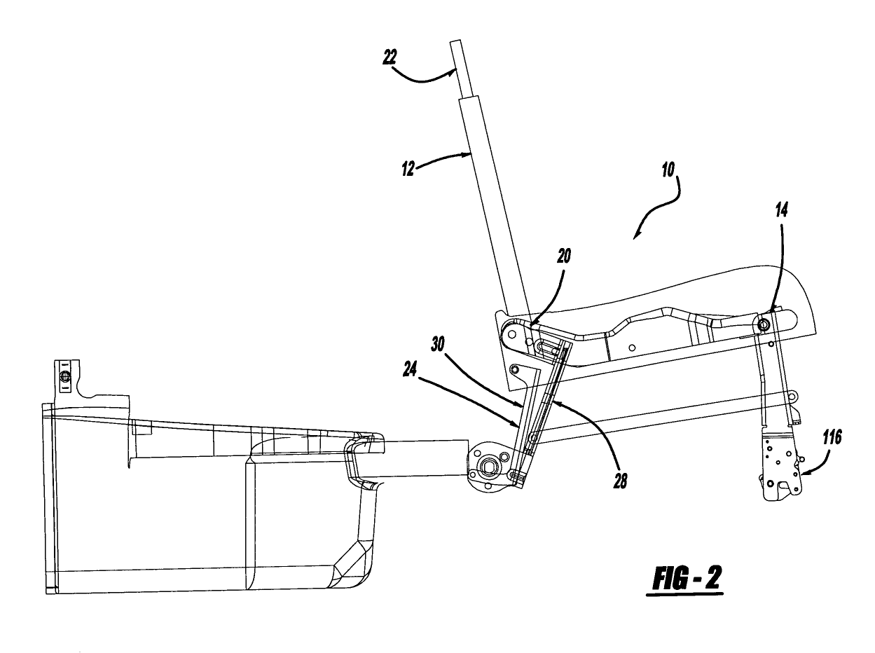

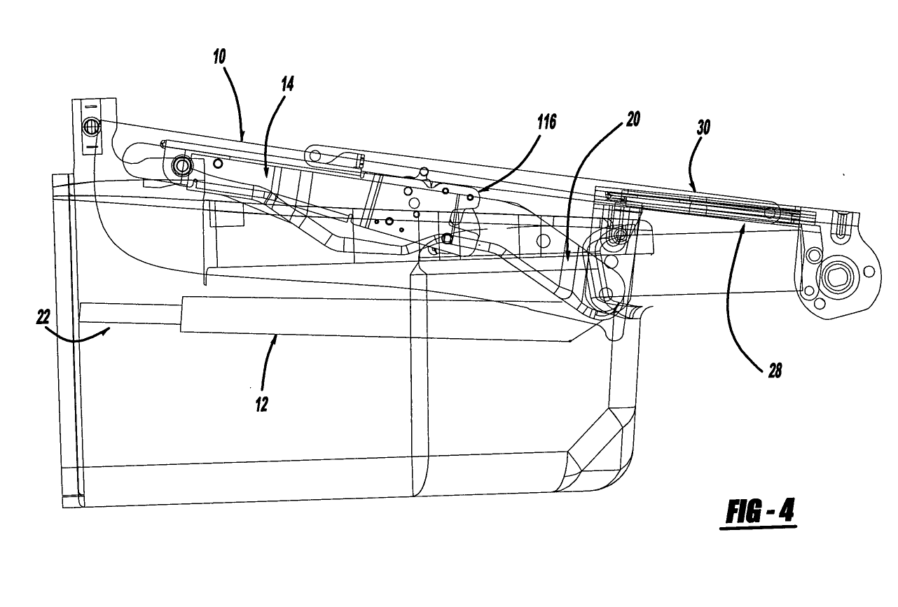

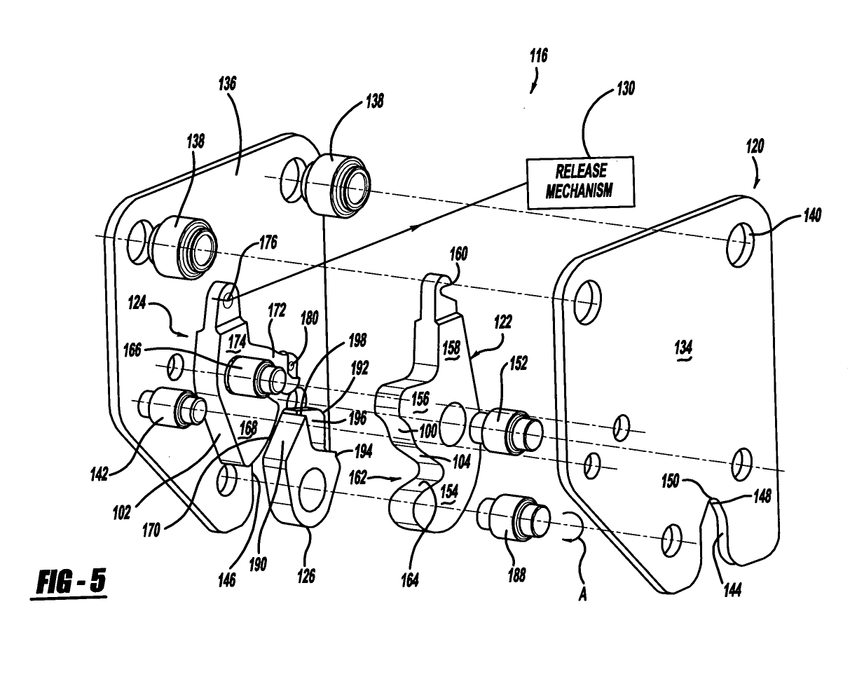

With reference to FIGS. 5-8, the front floor mounting assembly 16 is shown to include a floor latch mechanism 116. The floor latch mechanism 116 is rotatably supported by the seat adjustment mechanism 10 and is movable between an extended position and a retracted position. The floor latch mechanism 116 is in the extended position when the seat adjustment mechanism 10 is in a use position (FIGS. 1 and 2) to engage the external structure and prevent articulation of the seat adjustment mechanism 10 relative to the structure. The floor latch mechanism 116 is rotated from the extended position when the seat adjustment mechanism 10 is rotated into a stowed position (FIG. 4), as will be described further below.

With particular reference to FIGS. 5-8, the floor latch mechanism 116 will be described in detail. Floor latch mechanism 116 is preferably of the type disclosed in assignee's commonly-owned U.S. Pat. No. 6,412,849, the disclosure of which is incorporated herein by reference.

The floor latch mechanism 116 is operable in a latched mode for retaining the seat bottom frame 14 in a predetermined position relative to the external structure and in an unlatched mode for releasing the seat bottom frame 14 for movement relative to the external structure. In the embodiment illustrated in FIGS. 5-8, the external structure is shown to include a floor 114 having a striker pin 118 fixed thereto for engagement with the floor latch mechanism 116 when the floor latch mechanism 116 is in its latched mode.

The components of floor latch mechanism 116 will now be described in detail with reference to FIG. 5. Specifically, floor latch mechanism 116 includes a housing 120, latch 122, release cam 124, locking cam 126, and spring 128. Floor latch mechanism 116 also includes a release mechanism 130 for moving the latching assembly from its latched mode to its unlatched mode such as by rotating latch 122. Release mechanism 130 is schematically illustrated in FIG. 5 and those skilled in the art will appreciate that a variety of mechanisms known in the art may be used including a handle actuated cable assembly or any of a variety of other mechanical or electromechanical mechanisms.

In general, housing 120 is configured to accommodate striker pin 118 within a striker opening 132 formed therein (FIG. 5). Latch 122 is movable into a latched position wherein the latch wedges the striker pin into striker opening 132. When the latching assembly is in its latched mode, spring 128 urges the latch 22 to rotate in a clockwise direction causing three-point metal-to-metal contact between the striker and housing/latch. Vibration of the vehicle, normally caused by vehicle motion, allows the bias of spring 128 to tighten the engagement of the latch and striker as well as the inter-engagement of the latch 122, release cam 124, and locking cam 126 thereby preventing chucking or chattering at the striker/housing interface.

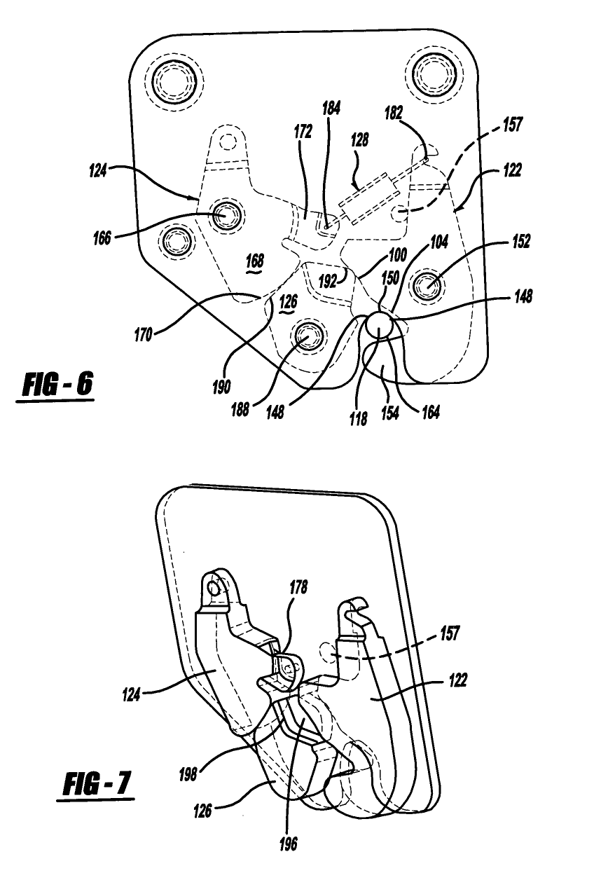

More particularly, housing 120 includes first and second plates 134 and 136 that are connectable to one another by spacer mounts 138 disposed in appropriately sized apertures 140. Housing 120 further includes a stop rivet 142 coupled to first and second plates 134 and 136. Plates 134 and 136 include identically configured striker recesses 144 and 146 that cooperate to define striker opening 132 in the assembled housing. Each of striker recesses 144 and 146 include a pair of planar contact segments 148 interconnected by an arcuate end face 150. As best illustrated in FIG. 6, planar contact segments 148 are sized and positioned within striker recesses 144 and 146 such that the striker pin 118 engages the housing at the planar contact segments thereby creating two points of metal to metal contact between the housing and the striker pin when the latching assembly is in its latched mode.

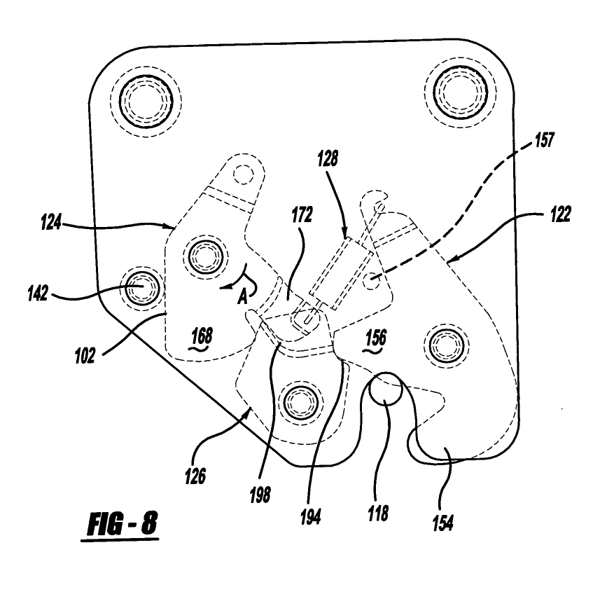

Latch 122 is pivotably coupled to housing 120 such as through a latch pivot 152 that is fixed to plates 134 and 136 thereby allowing the latch 122 to rotate between its latched position (FIG. 6) and its unlatched position (FIG. 8). Latch 122 is generally a plate-like component that includes a claw 154, a blocking leg 156, an upstanding leg 158 having a catch 160 formed on a distal end thereof, and a striker passage 162 between the claw 154 and blocking leg 156. Striker passage 162 is sized to accommodate striker pin 118 and includes a wedge face 164 for wedging the striker pin 118 against planar contact segments 148 within striker recesses 144 and 146. Those skilled in the art will appreciate that, as illustrated in FIG. 6, the wedge face 164 and planar contact segments 148 cooperate to define the three-point metal-to-metal contact between the latch 122, housing 120 and striker pin 118. This three-point contact effectively restrains the striker and, in cooperation with the bias of spring 128, reduces chucking.

As is generally described above, floor latch mechanism 116 further includes release cam 124 that is a plate-like component pivotably coupled to housing 120 such as by release pivot 166. More particularly, release cam 124 is pivotable in a first counterclockwise direction, direction “A”, toward an engaged position illustrated in FIG. 6 and in a second clockwise direction, opposite direction “A”, toward a disengaged position illustrated in FIG. 8. Release cam 124 includes an actuating leg 168 having an arcuate locking surface 170, a release leg 172 having a spring aperture 180, and an upstanding leg 174 having an aperture 176 connectable to release mechanism 130. As best illustrated in FIG. 7, release leg 172 has a recessed rear surface 178 to allow interlocking operative engagement of the release cam 124 with locking cam 126 as hereinafter described.

Spring 128 includes a first hooked end 182 connectable to catch 160 and a second hooked end 184 disposable within spring aperture 180. Spring 128 creates an axial biasing force that tends to draw the release leg 172 of the release cam 124 and the upstanding leg 158 of the latch 122 toward one another thereby tending to rotate the latch 122 in a counterclockwise direction about latch pivot 152 and toward its unlatched position and release cam 124 in a clockwise direction about release pivot 166 toward its engaged position. As will be described in greater detail below, the locking cam 126 is positioned to prevent counterclockwise rotation of latch 122 toward its unlatched position when the latching assembly is in its latched mode. As a result, when floor latch mechanism 116 is in its latched mode, spring 128 urges release cam 124 to rotate toward its engaged position shown in FIG. 6.

Locking cam 126 is inter-disposed between the release cam 124 and latch 122 to provide the operational features generally described above. More particularly, locking cam 126 is also a plate-like component coupled to housing 120 for pivotal movement about a locking pivot 188. Locking cam 126 is pivotable between a blocking position illustrated in FIG. 6 and a retracted position illustrated in FIG. 8. Locking cam 126 includes a generally planar engagement segment 190, an arcuate blocking segment 192 and a stop segment 194. Locking cam 126 further includes a recessed forward face 196 that defines a release segment 198 and that is configured to cooperate with recessed rear surface 178 as hereinafter described.

The respective positions of the latch, release cam, and locking cam will now be described when the latching assembly is in its latched mode as illustrated in FIG. 6 and its unlatched mode as illustrated in FIG. 8. The movement of these respective components of the latching assembly when the latching assembly is moved between its latched and unlatched modes will then be described in detail.

As shown in FIG. 6, when floor latch mechanism 116 is in its latched mode, latch 122 is in its latched position, release cam 124 is in its engaged position, and locking cam 126 is in its blocking position. In these respective positions, the locking surface 170 of release cam 124 engages the engagement segment 190 of locking cam 126 to transfer the biasing of spring 128 from release cam 124 to the locking cam 126 thereby urging the locking cam 126 to rotate in a clockwise direction against latch 122. Next, the blocking segment 192 of blocking cam 126 engages the blocking leg 156 of latch 122 such as along an arcuate cam surface 200 thereof. This biased engagement between the locking cam and latch urges latch 122 to rotate in a clockwise direction toward its latched position and wedges the locking cam against the latch 122 to prevent counterclockwise rotation thereof. Accordingly, the biasing spring 128 urges the latch 126 in a clockwise direction toward its latched position. Thus, as floor latch mechanism 116 vibrates such as due to vehicle motion, the latch 122 is continually urged to rotate in the clockwise direction thereby tightening the wedge engagement with the striker pin and preventing chucking of the latch at the striker/housing interface.

In addition to the foregoing, the floor latch mechanism 116 may also be provided with a sensor 157. The latch 122 engages the sensor 157 when in the latched position, to thereby indicate to an external system, such as a controller (not shown), that the floor latch mechanism 116 is in the latched position. In so doing, the sensor 157 allows the controller to prevent actuation of the recliner assembly 22, and thus, positioning of the seat adjustment mechanism 10 into the use position, unless the floor latch mechanism 116 is in the latched position. Such control prevents use of the seat adjustment mechanism 10 unless the floor latch mechanism 116 is in the latched position and secured to the striker pin 118.

Turning now to the relative positions of the components of the floor latch mechanism when the floor latch mechanism is in its unlatched mode as shown in FIG. 8. In the unlatched mode, the latch 122 is in its unlatched position, the release cam 124 is in its disengaged position, and the locking cam 126 is in its retracted position. When so configured, the striker pin 118 and therefore seat bottom frame 14 is freely movable relative to lower frame member 124. Moreover, the claw 154 of latch 122 is substantially contained within the boundaries of housing 120 thereby presenting a desirable packaging configuration.

In the unlatched mode, a rear surface 202 of actuating leg 168 contacts stop rivet 142 to define the furthest clockwise rotation of release cam 124 and thereby its disengaged position. The cooperating configuration of release cam 124 and locking cam 126 allows the recessed rear surface 178 (FIG. 7) of release leg 172 to be disposed in opposed relation with recessed forward face 196 of locking cam 126 and release leg 172 to contact release segment 198 and maintain the locking cam 126 in its retracted position. The rotation of locking cam 126 from its blocking position to its retracted position permits the counterclockwise rotation of latch 122 under the urging of spring 128. Latch 122 is fully rotated into its unlatched position when blocking leg 156 engages stop segment 194 of locking cam 126.

It should be appreciated that the floor latch mechanism 116 is configured to remain in its latched mode until an operator actuates release mechanism 130 and in its unlatched mode until the striker pin is disposed within striker opening 132. More specifically, floor latch mechanism 116 is moved from its latched mode to its unlatched mode by rotating release cam 124 in its clockwise direction causing disengagement of locking surface 170 and engagement segment 190. After a predetermined angular displacement of about 30°, release leg 172 engages release segment 198 where upon continued clockwise rotation of release cam 124 causes counterclockwise rotation of locking cam 126. When blocking segment 192 of locking cam 126 is rotationally displaced out of engagement with cam surface 200, latch 122 rotates under the force of elongated spring 128 in a counterclockwise direction until blocking leg 156 contacts stop segment 194.

Movement of floor latch mechanism 116 from its unlatched mode to its latched mode is initiated by displacement of striker pin 118 into striker opening 132. More particularly, as seat bottom frame 14 is moved into its set position, striker pin 118 is displaced into striker opening 132 and into contacting engagement with a bearing surface 204 of latch 122. Further movement of the striker pin 118 displaces latch 122 in a clockwise direction. After blocking leg 156 clears blocking segment 192, locking cam 126 is free to rotate in a clockwise direction under the urging of spring 128 via contacting engagement of locking surface 170 and engagement segment 190. Those skilled in the art will appreciate that the full disposition of striker pin 118 within striker opening 132 as well as the progressive tightening of the wedged engagement between claw 154 and striker pin 118 described above insures full placement of the latching assembly in its latched mode.

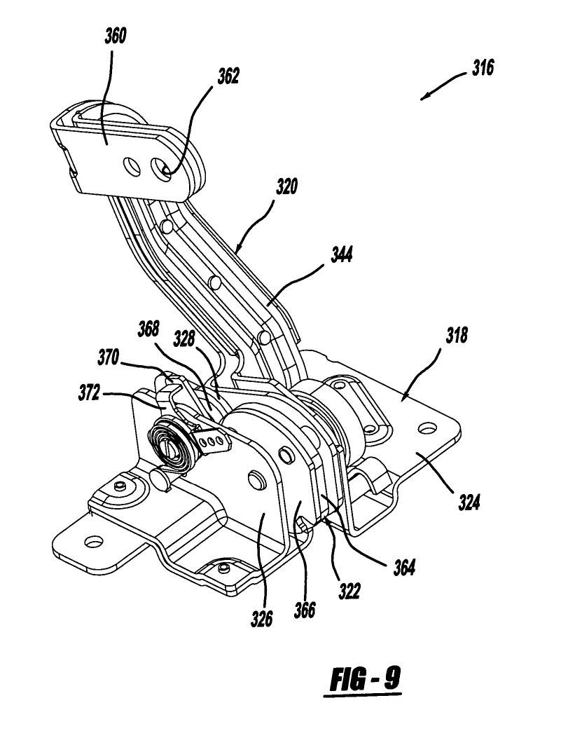

With reference to FIGS. 9-16, the rear floor mounting assembly 18 is shown to include a stow pivot assembly 316. The stow pivot assembly 316 is preferably of the type disclosed in assignee's commonly-owned U.S. patent application Ser. No. 10/889,653, filed Jul. 12, 2004, the disclosure of which is incorporated herein by reference.

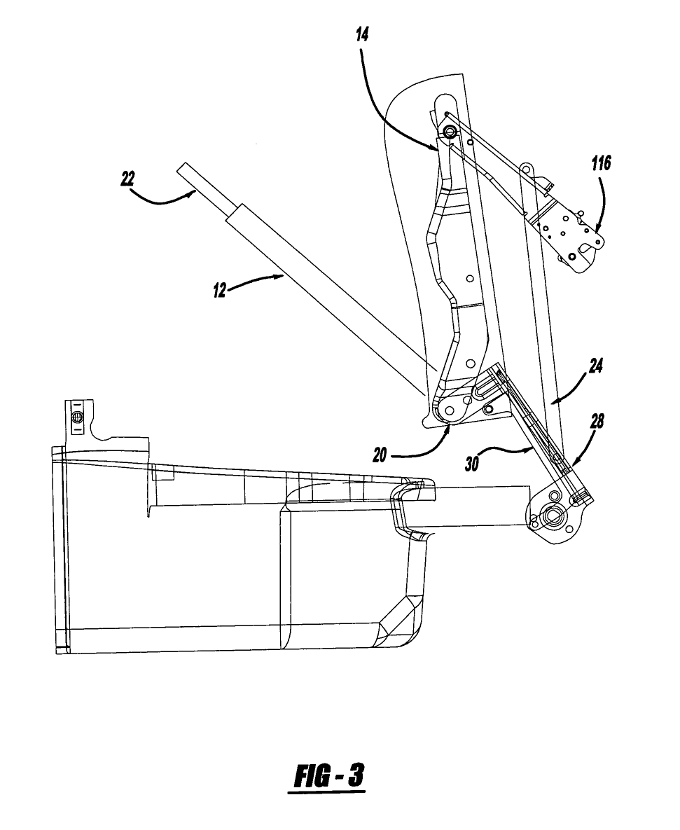

The stow pivot assembly 316 generally includes a support subassembly 318, an arm subassembly 320, and a locking subassembly 322. The seat bottom frame 14 is pivotally attached to the arm subassembly 320. The arm subassembly 320 is pivotable relative to the support subassembly 318 to configure the seat adjustment mechanism 10 between a use position (FIGS. 1 and 2) and a stowed position (FIG. 4). In the embodiment illustrated, the seat adjustment mechanism 10 must pivot relative to the arm subassembly 320, as is illustrated in FIG. 3, to complete the transition between the seating and stowed positions. It should be appreciated, however, that in an alternative embodiment the seat adjustment mechanism 10 is fixedly attached to the stow pivot assembly 316 and need not pivot or rotate relative thereto.

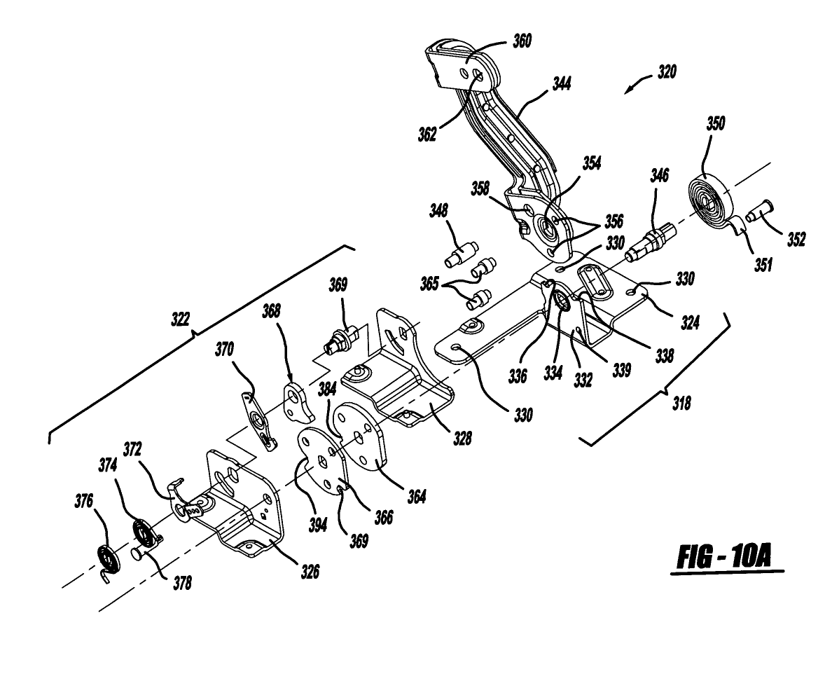

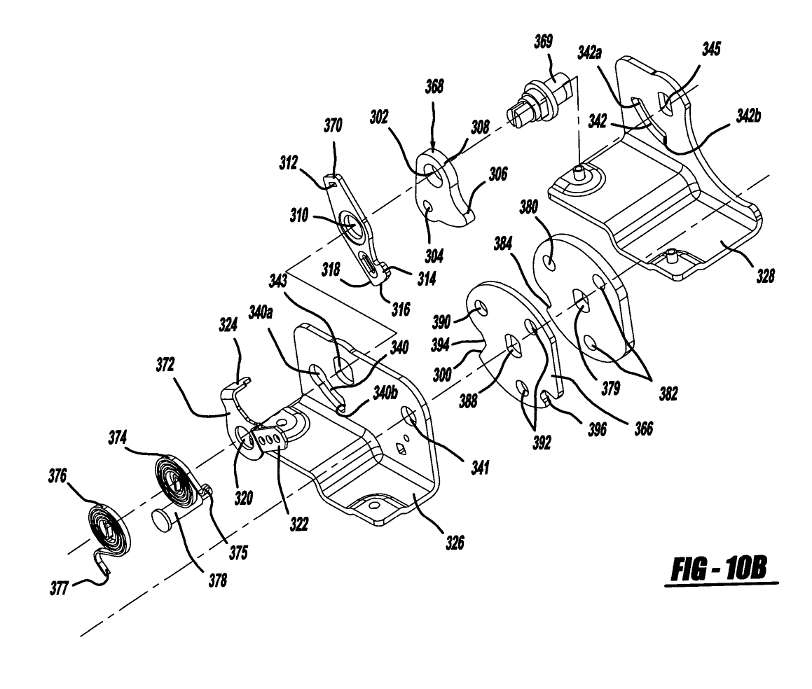

With reference to FIGS. 10A and 10B, the support subassembly 318 includes a major support bracket 324, a first minor support bracket 326, and a second minor support bracket 328. The major support bracket 324 includes a plurality of fixation apertures 330 and a control flange 332. The plurality of fixation apertures 330 is adapted to receive a plurality of fasteners (not shown) to attach the major support bracket 324 to the external structure, such as a vehicle floor. The control flange 332 includes a main pivot aperture 334, a biasing pin aperture 339, a first stop surface 336, and a second stop surface 338. The first minor support bracket 326 includes an arcuate slot 340, a cam pivot aperture 343, and a central pivot aperture 341. The second minor support bracket 328 includes an arcuate slot 342 and a cam pivot aperture 345. The second minor support bracket 328 is disposed between the major support bracket 324 and minor support bracket 326. The arcuate slots 340, 342 in the first and second minor support brackets 326, 328 are substantially aligned with each other to define stowed surfaces 340a, 342a and seated surfaces 340b, 342b.

The arm subassembly 320 generally includes an arm member 344, a central pivot pin 346, a stop pin 348, a biasing member 350, and a biasing pin 352. The arm member 344 includes a central aperture 354, a pair of rivet apertures 356, a stop pin aperture 358, a seat flange 360, and a seat fixation aperture 362 (shown in FIGS. 10A and 10B).

The locking subassembly 322 includes a high load sector plate 364, a low load sector plate 366, a high load cam 368, a low load cam 370, a release lever 372, a first biasing member 374, a second biasing member 376, a guide pin 378, and a cam pivot 369. The locking subassembly 322 is adapted to lock the arm subassembly 320 in a first position, shown in FIG. 1, and a second position, shown in FIG. 4. In one embodiment, the release lever 372 is operably connected to the floor latch mechanism 116 such that upon release of the floor latch mechanism 116 from striker pin 118, the locking subassembly 322 is similarly released to thereby allow the seat bottom frame 14 to rotate relative to the external structure, as will be described further below.

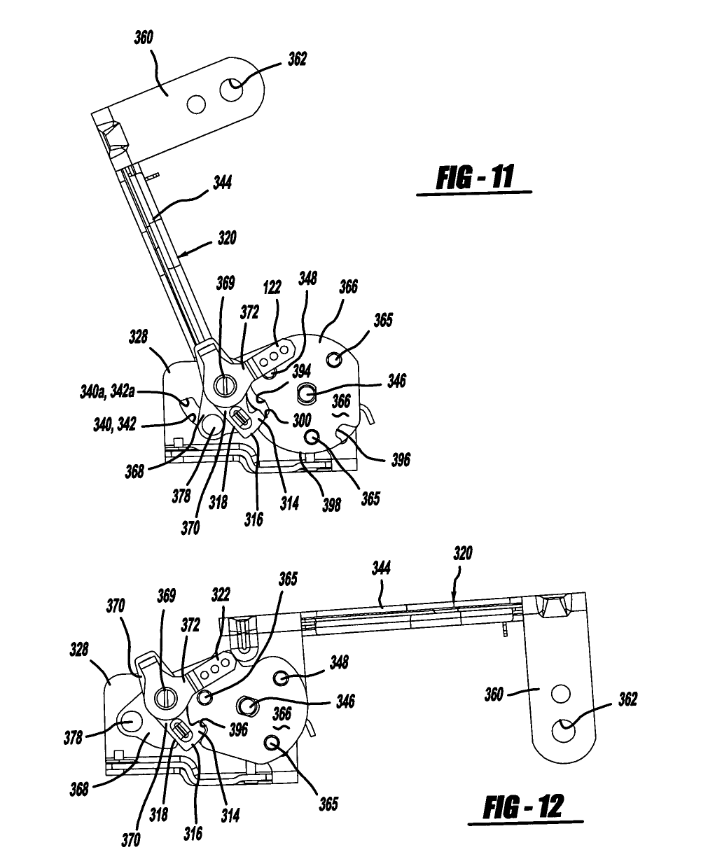

The high load sector plate 364 includes a central aperture 379, a stop pin aperture 380, a pair of rivet apertures 382, a notch 384, and an arcuate surface 386. The low load sector plate 366 includes a central aperture 388, a stop pin aperture 390, a pair of rivet apertures 392, a first notch 394, a second notch 396, and an arcuate surface 398. The first notch 394 includes an engaging surface 400 (shown in FIGS. 11 and 12). The high load cam 368 includes a pivot aperture 402, a slide pin aperture 404, a nose 406, and an arcuate edge 408. The low load cam 370 includes a pivot aperture 410, a release lever aperture 412, a nose 414, a cam edge 416, and an unlocking edge 418. The release lever 372 includes a central aperture 420, a handle 422, and a connector flange 424.

With continued reference to FIGS. 10A and 10B, the stow pivot assembly 316 is assembled as follows. The central pivot pin 346 of the arm subassembly is disposed through the central aperture 354 of the arm member 344, the main pivot aperture 334 of the control flange 332 of the major support bracket 324, the central aperture 388 of the low load sector plate 366, the central aperture 379 of the high load sector plate 364, and the central pivot aperture 341 of the first minor support bracket 326. The biasing member 350 of the arm subassembly 320 is also disposed on the central pivot pin 346. The biasing member 350 includes a coil spring having an arm 351 engaging the biasing pin 352. The biasing pin 352 is fixedly disposed in the biasing pin aperture 339 of the control flange 332 of the major support bracket 324. The biasing member 350 biases the arm subassembly 320 into the use position illustrated in FIG. 1.

As stated above, the high load sector plate 364 and low load sector plate 366 are disposed on the central pivot pin 346. The high load sector plate 364 and low load sector plate 366 are fixedly attached to the arm member 344 via a pair of rivets 365. The pair of rivets 365 are received in the rivet apertures 356 of the arm member 344, the rivet apertures 382 of the high load sector plate 364, and the rivet apertures 392 of the low load sector plate 366. The rivets 365 attach the high and low load sector plates 364, 366 to the arm member 344.

The stop pin 348 of the arm subassembly 320 is disposed in the stop pin aperture 358 of the arm member 344, the stop pin aperture 380 of the high load sector plate 364, and the stop pin aperture 390 of the low load sector plate 366. Therefore, the arm member 344, high and low load sector plates 364, 366, and the stop pin 348 all rotate together upon pivotal displacement of the arm member 344 relative to the support subassembly 318.

The cam pivot 369 is disposed in the pivot aperture 402 of the high load cam 368, the pivot aperture 410 of the low load cam 370, the cam pivot aperture 343 of the first minor support bracket 326, the cam pivot aperture 345 of the second minor support bracket 328, and the central aperture 420 of the release lever 372. Additionally, the first and second biasing members 374, 376 of the locking subassembly 322 are disposed on the cam pivot 369. The first biasing member 374 includes a coil spring having an arm 375 engaging the handle 422 of the release lever 372 to bias the low load cam 370 into the low load sector plate 366. The second biasing member 376 includes a coil spring similar to the first biasing member 374 having an arm 377 engaging the guide pin 378. The guide pin 378 is disposed in the arcuate slots 340, 342 of the first and second minor support brackets 326, 328 of the support subassembly 318. It should be appreciated that the arcuate slots 340, 342 act as clearance slots to provide an unobstructed travel path for the guide pin 378 during actuation of the stow pivot assembly 316. The guide pin 378 is further disposed in and staked to the slide pin aperture 404 of the high load cam 368. Therefore, the second biasing member 376 biases the high load cam 368 into engagement with the high load sector plate 364.

FIG. 11 depicts the stow pivot assembly 316 in a use position having the first minor support bracket 326 removed to expose the low load cam 370 and low load sector plate 366. In this position, the nose 414 of the low load cam 370 is received in the first notch 394 of the low load sector plate 366. The cam edge 416 of the low load cam 370 frictionally engages the engaging surface 400 of the first notch 394. This provides a torque to the low load sector plate 366 in a counterclockwise direction, as shown in FIG. 11. It should be appreciated that the first biasing member 374 (shown in FIG. 9) of the locking subassembly 322 ensures the above engagement by biasing the low load cam 370 into the low load sector plate 366.

FIG. 13 depicts the stow pivot assembly 316 in the use position having the first minor support bracket 326 removed to expose the high load cam 368 and high load sector plate 364. In this position, the nose 406 of the high load cam 368 is received in the notch 384 of the high load sector plate 364. The nose 406 of the high load cam 368 restricts rotational displacement of the high load sector plate 364 and, therefore, the arm subassembly 320 under high loads applied thereto. Additionally, the guide pin 378 supported by the high load cam 368 is positioned in the arcuate slots 340, 342 of the first and second minor support brackets generally adjacent to the seated surfaces 340b, 342b. However, the guide pin 378 only engages seated surface 340b and not seated surface 342b. It should be appreciated that the second biasing member 376 (shown in FIG. 9) of the locking subassembly 322 ensures the above engagement by biasing the guide pin 378, and therefore, the high load cam 368 into the high load sector plate 364.

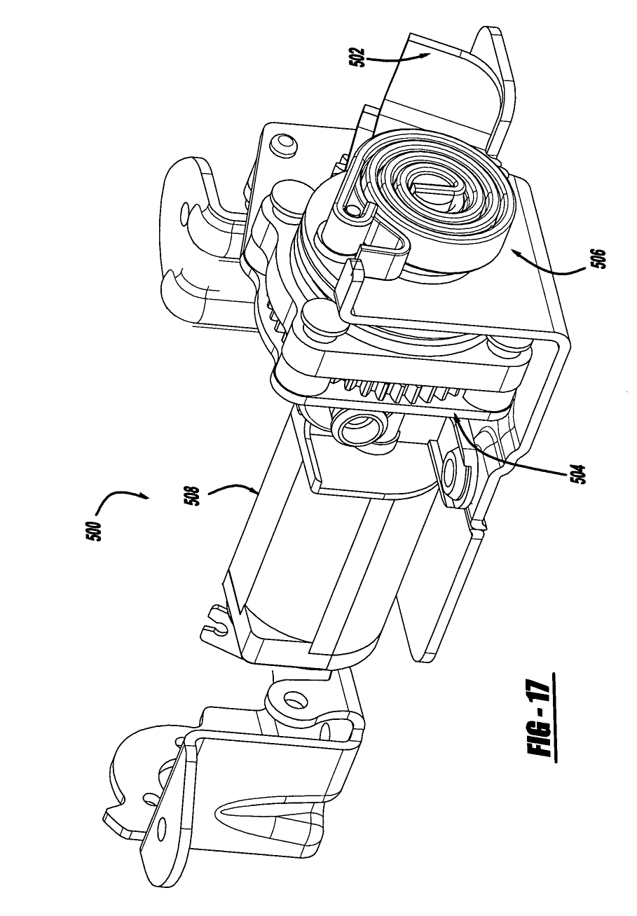

FIG. 15 depicts the stow pivot assembly 316 in the use position having the minor support brackets 326, 328, the load cams 368, 370, and the sector plates 364, 366 removed to expose the position of the stop pin 348 of the arm subassembly 320. The stop pin 348 engages the first stop surface 336 of the control flange 332 of the major support bracket 324. The stop pin 348, therefore, limits the counterclockwise rotation of the arm subassembly 320 relative to the support subassembly 318, as viewed in FIGS. 11-16.

FIG. 12 depicts the stow pivot assembly 316 in a stowed position having the first minor support bracket 326 removed to expose the low load cam 370 and low load sector plate 366. The nose 414 of the low load cam 370 is received in the second notch 396 of the low load sector plate 366. This locks the low load sector plate 366 and, therefore, the arm subassembly 320 in the stowed position. It should be appreciated that the first biasing member 374 (shown in FIG. 9) of the locking subassembly 322 ensures the above engagement by biasing the low load cam 370 into the low load sector plate 366.

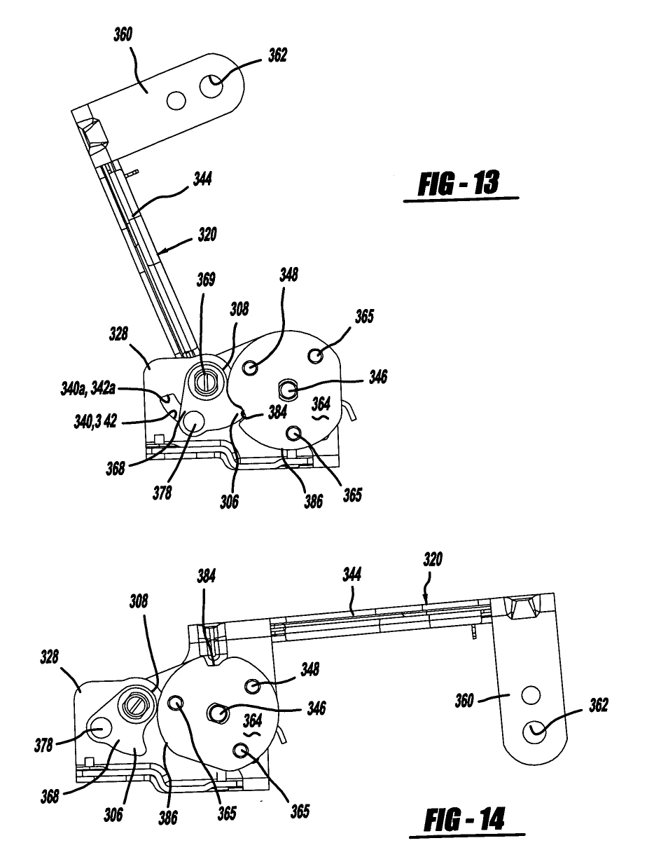

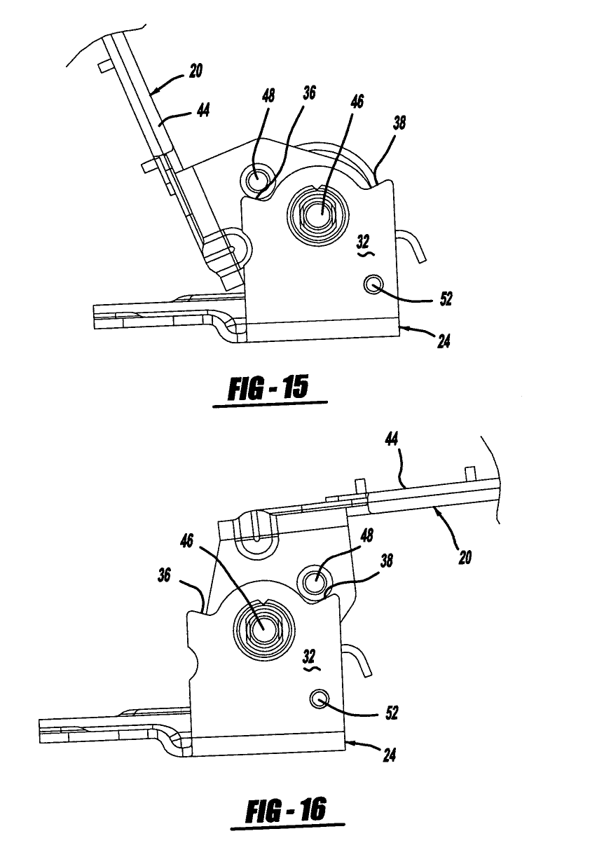

FIG. 14 depicts the stow pivot assembly 316 in the stowed position having the first minor support bracket 326 removed therefrom to expose the high load cam 368 and the high load sector plate 364. The guide pin 378 is disposed in the slide pin aperture 404 of the high load cam 368 generally adjacent to the stowed surfaces 340a, 342a of the arcuate slots 340, 342 in the first and second minor support brackets 326, 328. It should be appreciated that in the present embodiment, the guide pin 378 does not engage the stowed surfaces 340a, 342a. The arcuate edge 408 of the high load cam 368 slidably engages the arcuate surface 386 of the high load sector plate 364. It should be appreciated that the high load cam 368 does not lock the high load sector plate 364 in this stowed position.

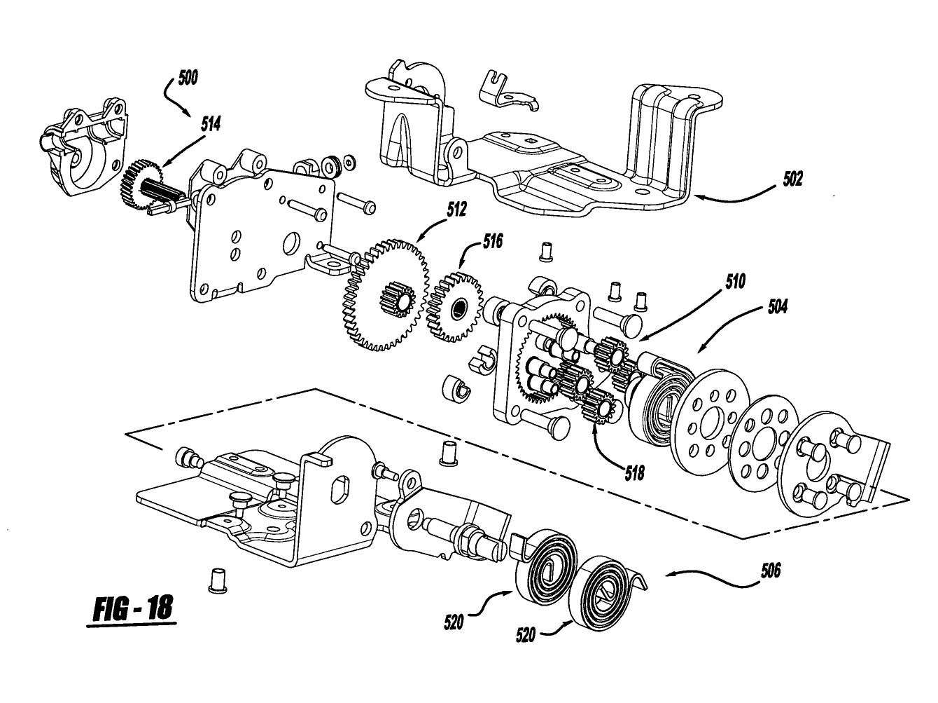

FIG. 16 depicts the stow pivot assembly 316 in the stowed position have the minor support brackets 326, 328, the load cams 368, 370, and the sector plates 364, 366 removed to expose the position of the stop pin 348 of the arm subassembly 320. The stop pin 348 engages the second stop surface 338 of the control flange 332 of the major support bracket 324. The stop pin 348, therefore, limits the clockwise rotation of the arm subassembly 320 relative to the support subassembly 318, as viewed in FIGS. 11-16.

The following steps describe the transition between the seating and stowed positions for the stow pivot assembly 316. With the stow pivot assembly 316 in the use position, as shown in FIGS. 11 and 13, a moment is applied to the handle 422 of the release lever 372 in a clockwise direction. In one embodiment, the force applied to release lever 372 via handle 422 is caused by a force being applied to the release mechanism 130 of the floor latch mechanism 116. Specifically, as a user applies a force to the release mechanism 130, to thereby unlatch the floor latch mechanism 116, the force is transmitted to the release lever 372 via a tension member, such as, but not limited to, a cable (not shown). The tension member transmits the force to the release lever 372 via handle 422 to release the stow pivot assembly 316 and permit the arm subassembly 320 to begin rotating clockwise toward the stowed position, as will be described further below.

This moment is transferred to the low load cam 370 via the connector flange 424 of the release lever 372. Thus, the low load cam 370 begins to pivot in the clockwise direction such that the cam edge 416 disengages the engaging surface 400 of the first notch 394 of the low load sector plate 366. Further rotation of the release lever 372 and, therefore, the low load cam 370 causes the unlocking edge 418 of the low load cam 370 to engage the guide pin 378. This causes the guide pin 378 to displace away from the seated surfaces 340b, 342b of the arcuate slots 340, 342 of the first and second minor support brackets 326, 328. The nose 406 of the high load cam 368 is then relieved from the notch 384 in the high load sector plate 364. Once this occurs, the high and low load sector plates 364, 366, as well as the arm subassembly 320, are free to begin rotating clockwise toward the stowed position illustrated in FIGS. 12, 14 and 16. Once this rotation begins, the clockwise force applied to the handle 422 of the release lever 372 may be released. Upon release of the release lever 372, the first biasing member 374 biases the release lever 372 counterclockwise such that the nose 414 of the low load cam 370 slidably engages the arcuate surface 398 of the low load sector plate 366. Additionally, the second biasing member 376 biases the guide pin 378 and high load cam 368 counterclockwise such that the nose 406 of the high load cam 368 slidably engages the arcuate surface 386 of the high load sector plate 364. This continues until the nose 414 of the low load cam 370 is aligned with the second notch 396 of the low load sector plate 366. Upon alignment, the first biasing member 374 biases the nose 414 of the low load cam 370 into the second notch 396 of the low load sector plate 366. This locks the low load sector plate 366 and, therefore, the arm subassembly 320, in the stowed position illustrated in FIGS. 12, 14 and 16.

To return the stow pivot assembly 316 to the use position illustrated in FIGS. 11, 13 and 15, a clockwise force is again applied to the handle 422 of the release lever 372 (i.e., via floor latch mechanism 116, as previously discussed). The applied force removes the nose 414 of the low load cam 370 from the second notch 396 in the low load sector plate 366. A counterclockwise force may then be applied to the arm subassembly 320 to move the arm subassembly 320 and high and low load sector plates 364, 366 to the use position illustrated in FIGS. 11, 13 and 15. Once sufficient rotation has been accomplished, the clockwise force applied to the handle 422 of the release lever 372 may be released. This enables the first biasing member 374 to bias the nose 414 of the low load cam 370 into the first notch 394 of the low load sector plate 366. Consequently, the cam edge 416 of the low load cam 370 frictionally engages the engaging surface 400 of the first notch 394, thereby applying a counterclockwise torque to the low load sector plate 366. Additionally, the second biasing member 376 biases the nose 406 of the high load cam 368 into the notch 384 of the high load sector plate 364. It should be appreciated that the interconnection between the high load cam 368 and high load sector plate 364 prevents pivotal displacement of the arm subassembly 320 in reaction to large forces. Additionally, it should be appreciated that the frictional engagement between the cam edge 416 of the low load cam 370 and the engaging surface 400 of the first notch 394 of the low load sector plate 366 prevents minute pivotal displacement of the arm subassembly 320 in reaction to low forces.

The stow pivot assembly 316 of the present invention provides the ability to lock the seat adjustment mechanism 10 in both the use and stowed positions. It should further be appreciated that while the above-described embodiment includes a high load sector plate 364 interacting with a high load cam 368 and a low load sector plate 366 interacting with a low load cam 370 to achieve this multi-locking feature, a stow pivot assembly 316 including a single sector plate and load cam is intended to be within the scope of the present invention. It is envisioned that an alternative embodiment of the stow pivot assembly 316 only includes the low load sector plate 366 and the low load cam 370. The interaction and engagement between the low load sector plate 366 and low load cam 370, as described above in accordance with the first embodiment, would sufficiently deter loads being applied to the arm subassembly 320 by maintaining the stow pivot assembly 316 in a locked state.

In lieu of the stow pivot 316, the rear floor mounting assembly 18 could alternatively include a power system 500. Power system 500 allows a user to position the seat adjustment mechanism 10 from the use position to the stowed position through actuation of a single button 501. When the button 501 is depressed, power is not only supplied to power system 500, but also to respective power systems associated with the front floor mounting assembly 16, recliner assembly 20, and headrest assembly 22 to provide “one-touch” operation of the seat adjustment mechanism 10, as will be described further herein below.

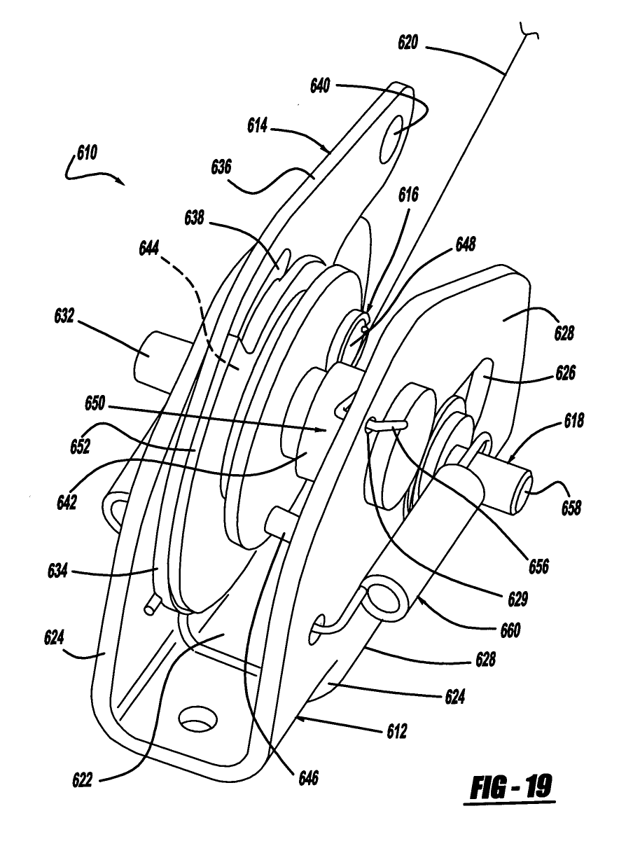

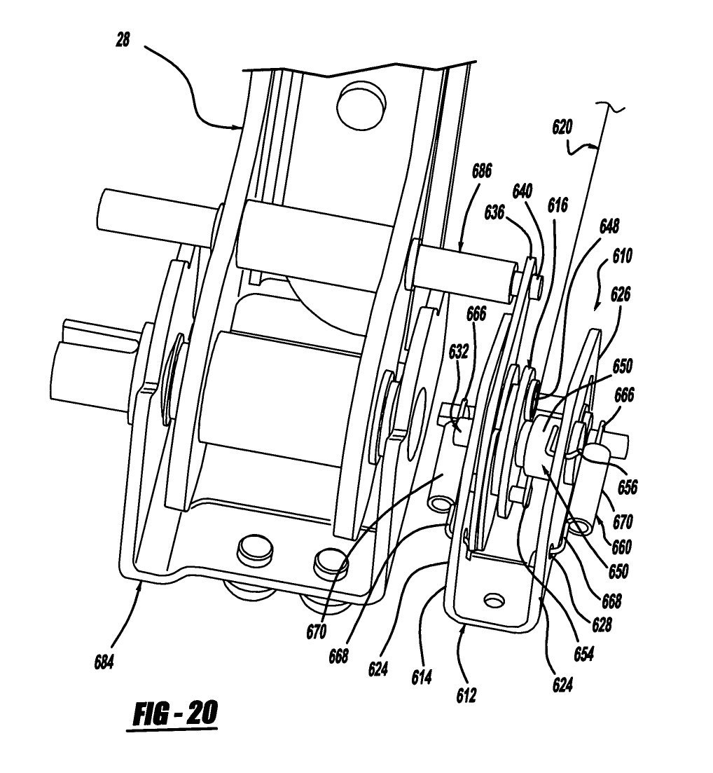

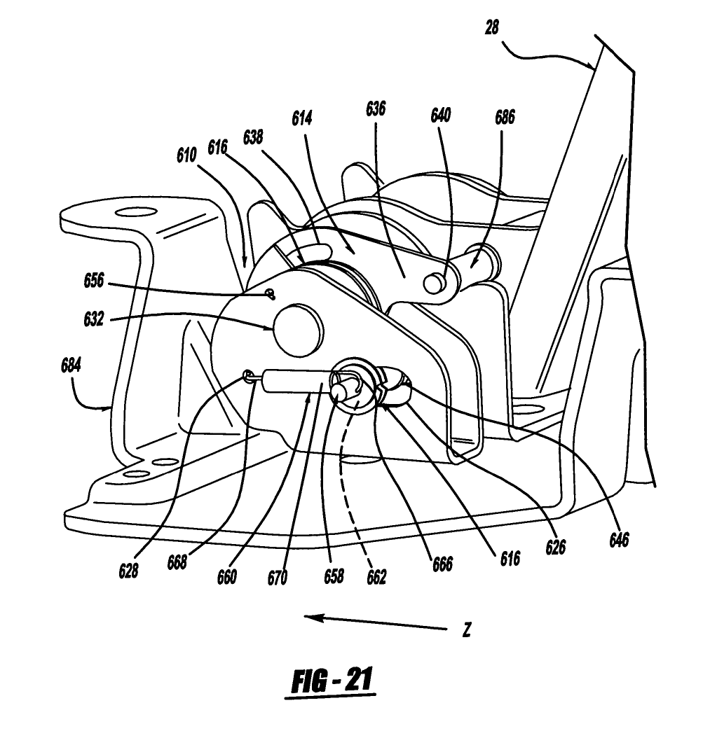

With reference to FIGS. 17 and 18, the power system 500 is shown to include a housing 502, a gear train 504, a lift assist system 506, and a motor 508. The housing 502 operably supports the gear train 504, lift assist system 506, and motor 508 and fixedly attaches each component to the external structure.

The gear train 504 is driven by motor 508 and includes a planetary gear seat 510, a sun gear 512, and a pair of intermediate gears 514, 516. In operation, a rotational force is imparted on the gear train 504 by motor 508, generally at intermediate gear 514. Rotation of intermediate gear 514 causes rotation of planetary gears 518 of planetary gear set 510. The planetary gears 518 rotate the sun gear 512 through interaction with intermediate gear 516. The sun gear 512 has a greater diameter than intermediate gear 514 and, as such, allows the motor 508 to rotate the sun gear 512 at a reduced speed and at a higher torque when compared to intermediate gear 514. The reduced gear ratio allows the motor 508 to rotate the sun gear 512 with sufficient torque to rotate the seatback frame 12 and seat bottom frame 14 relative to the external structure, as will be described further below.

The lift assist system 506 includes a pair of coil springs 520 that help the power system 500 actuate the seatback frame 12 and seat bottom frame 14 from the use position to the stowed position. Specifically, when the seatback frame 12 and seat bottom frame 14 are moved from the stowed position to the use position, the weight of the seatback frame 12 and seat bottom frame 14 act against the bias imparted thereon by coil springs 520. In this manner, when the seatback frame 12 and seat bottom frame 14 are in the use position, the coil springs 520 are unwound and have stored kinetic energy. Therefore, when the floor latch mechanism 116 is released and the power system 500 (via motor 508) is permitted to rotate the seatback frame 12 and seat bottom frame 14 relative to the external structure, the coil springs 520 release the stored kinetic energy, thereby helping the motor 508 rotate the seatback frame 12 and seat bottom frame 14 into the stowed position.

In operation, a user depresses an actuation button 501 to first release the floor latch mechanism 116. Once the floor latch mechanism 116 is released, the sensor 197 relays an event message to a system controller 503 that the floor latch mechanism 116 is unlatched and that rotation of the seatback frame 12 and seat bottom frame 14 relative to the external structure is possible. When the system controller 503 receives the event message from sensor 197, the system energizes motor 508 to thereby rotate the seatback frame 12 and seat bottom frame 14 relative to the external structure.

As previously discussed, the motor 508 is able to rotate the seatback frame 12 and seat bottom frame 14 relative to the external structure due to the planetary gear set 510 and coil springs 520. Once the seatback frame 12 and seat bottom frame 14 are in the stowed position, the seatback frame 14 is essentially parallel to the seat bottom frame 14, as best shown in FIG. 4.

To ensure that the seatback frame 12 and seat bottom frame 14 are parallel to external structure when in the stowed position, the seat adjustment mechanism 10 uses either a four-bar link system 24 or a linear recliner mechanism 26.

The four-bar link system 24 is disposed generally between the seat bottom frame 14 and the external structure and includes a support link 28 and a pivot link 30. The support link 28 is rotatably attached to the seat bottom frame 14 at a first end and rotatably attached to the external structure at a second end such that the seat bottom frame 14 is rotatably supported by the support link 28. Similarly, the pivot link 30 is pivotally supported by the seat bottom frame 14 at a first end and by the external structure at a second end.

The support link 28 and pivot link 30 are attached to the seat bottom frame 14 and external structure at different points. Therefore, cooperation between the seat bottom frame 14, external structure, support link 28, and pivot link 30 create a four-bar linkage. The four-bar linkage allows the motor 508 to drive the seatback frame 12 and seat bottom frame 14 into the stowed position such that the seat bottom frame 14 is substantially parallel to the external structure. The four-bar link system 24 essentially allows the seat bottom frame 14, and thus the seatback frame 12, to rotate relative to the support link 28 and therefore effectively adjusts the pivot point of the seat bottom frame 14.

For example, if the seat bottom frame 14 were only supported by the support link 28, the seatback frame 12 and seat bottom frame 14 would be positioned at an angle relative to the external structure as a leading edge of the seatback frame 12 would contact the external structure and prohibit further rotation of the seatback frame 12 and seat bottom frame 14 relative to the external structure. However, the four-bar link system 24 allows the motor 508 to further drive the seatback frame 12 and seat bottom frame 14 when in an angular position relative to the external structure as the pivot link 30 provides for angular adjustment of the seat bottom frame 14, and thus the seatback frame 12, relative to the support link 28. As such, the four-bar link system 24 allows the motor 508 to drive the seatback frame 12 and seat bottom frame 14 into the stowed position until the seatback frame 12 and seat bottom frame 14 are substantially parallel to the external structure.

The linear recliner mechanism 26 is disposed generally on the seat bottom frame 14 and is used to drive the seatback frame 12 and seat bottom frame 14 into the stowed position such that the seatback frame 12 and seat bottom frame 14 are substantially parallel to the external structure. Specifically, the linear recliner mechanism 26 is fixedly attached to the seat bottom frame 14 at a first end and operably attached to the support link 28 at a second end. Therefore, actuation of the linear recliner mechanism 26 applies a force on the seat bottom frame 14, thereby rotating the seat bottom frame 14 relative to the support link 28. Therefore, when the seatback frame 12 and seat bottom frame 14 are positioned at an angle relative to the external structure (as previously discussed), the linear recliner mechanism 26 applies a force on the support link 28 to thereby rotate the seat bottom frame 14 relative to the support link 28 until the seat bottom frame 14, and thus the seatback frame 12, are substantially parallel to the support link 28.

As described, the power system 500 cooperates with either, or both of, the four-bar system 24 and linear recliner mechanism 26 to provide one-touch articulation of the seatback frame 12 and seat bottom frame 14 from the use position (FIGS. 1 and 2) to the stowed position (FIG. 4).

In addition to powered operation, the seat adjustment mechanism 10 also allows for manual adjustment of the seatback frame 12 and seat bottom frame 14 relative to the external structure. Such a configuration does not require the power system 550, the four-bar link system 24, or the linear recliner mechanism 26. Rather, such a system simply includes a pivot arrangement disposed generally at the rear floor mount assembly 18 and a series of coil springs 32 disposed generally at the junction of the seatback frame 12 and seat bottom frame 14 (in addition to the front floor mount assembly 16, recliner assembly 20, and headrest assembly 22, as will be described further below).

In the manual operation, the seat bottom frame 14 is rotatably supported by a pivot assembly 34 disposed generally at the rear floor mount assembly 18, as best shown in FIG. 1. The pivot assembly 34 is pivotally connected to the support link 28 and includes a series of coil springs 36. The coil springs assist rotation of the seatback frame 12 and seat bottom frame 14 from the use position to the stowed position. As described, the pivot assembly 34 serves as a pivot point for the support link 28 during rotation of the seatback frame 12 and seat bottom frame 14 relative to the external structure and, as such, does not lock the support link 28 relative to the external structure either in the use position or the stowed position.

Coil springs 32 are disposed generally at the junction between the seatback frame 12 and the seat bottom frame 14, as previously discussed. The coil springs 32 maintain the rigidity of the seat adjustment mechanism 10 when in the use position (FIGS. 1 and 2). In other words, the coils springs 32 prevent rotation of the support link 28 about the pivot assembly 34 and therefore provide stability for the seat adjustment mechanism 10 when in the use position.

With reference to FIGS. 20-24, an actuation mechanism 610 is provided and includes a housing 612, a release plate 614, a cable plate 616, and a lock mechanism 618. The actuation mechanism 610 allows the recliner mechanism 20 to lock the seatback frame 12 to the seat bottom frame 14 once the seatback frame 12 and seat bottom frame 14 are in the stowed position, as will be described further below.

The release plate 614 selectively toggles the lock mechanism 618 between a locked position and an unlocked position to selectively allow the cable plate 616 to rotate relative to the housing 612. Rotation of the cable plate 616 relative to the housing 612 relieves tension in a tension member 620 associated with the cable plate 616, as will be discussed further below.

The housing 612 rotably supports the release plate 614 and cable plate 616 within a cavity 622 disposed generally between a pair of upwardly extending side walls 624. Each of the side walls 624 includes a slot 626, a spring aperture 628, and a pivot aperture 630. The slot 626 and spring aperture 628 cooperate to support the lock mechanism 618, while the pivot aperture 630 receives a pivot 632 for rotatably supporting the release plate 614 and the cable plate 616 generally within cavity 622 and between the side walls 624.

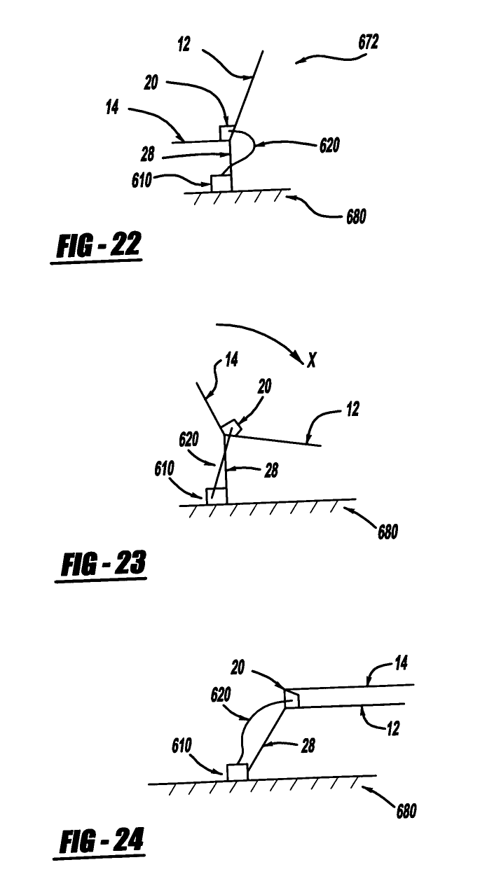

With reference to FIG. 21, the release plate 614 is shown rotatably supported by the pivot 632 generally between side walls 624 and includes a body 634 and a projection 636 extending from the body 634. The body 634 includes a slot 638 while the projection 636 includes an attachment aperture 640. The slot 638 selectively interacts with the cable plate 616 while the attachment aperture 640 operably connects the actuation mechanism 610 to an external device, as will be described further below.

The cable plate 616 is rotatably supported by pivot 632 generally between side walls 624 and includes a body 642, a return post 644, a spring post 646, and an attachment aperture 648. The body 642 rotatably receives the pivot 632 such that the cable plate 616 is free to rotate about the pivot 632 relative to the housing 612. The return post 644 extends from the cable plate 616 and is slidably received in slot 638 of the release plate 614 while the spring post 646 extends from an opposite side of the cable plate 616 than the return post 644 and interacts with a coil spring 650. Attachment aperture 648 receives one end of the tension member 620 such that the tension member 620 is fixed for rotation with the cable plate 616.

The coil spring 650 biases the cable plate 616 in the counterclockwise direction relative to the view shown in FIG. 21 and includes a coiled main body 652 and a pair of legs 654, 656 extending therefrom. One of the legs 654 engages spring post 646 while the other of the legs 656 is seated within a spring aperture 629 of the housing 612. In this manner, the spring 650 is supported generally between the side walls 624 by the pivot 632 and imparts a biasing force on the cable plate 616 to urge the cable plate 616 to rotate about the pivot 632 in the counterclockwise direction.

The cable plate 616 is prevented from rotating in the counterclockwise direction due to interaction with the lock mechansim 618. The lock mechansim 618 includes a lock post 658 and a pair of coil springs 660. The lock post 658 is slidably supported within slots 626 and is movable therein between a first end 662 and a second end 664. The lock post 658 prevents rotation of the cable plate 616 when disposed at the first end 662 through engagement with the cable plate 616 and permits rotation of the cable plate 616 (under bias of coil spring 650) relative to the housing 612 when disposed at the second end 664.

The lock post 658 is biased toward the first end 662 of slots 626 and, thus, into engagement with the cable plate 616, through interaction with springs 660. Specifically, each spring 660 includes a first leg 666 fixedly attached to the lock post 658 and a second leg 668 attached to the housing 612 at spring aperture 628. Each spring 660 further includes a coiled main body 670 that imparts a force on the lock post 658 in a direction “Z” (FIG. 21) to thereby bias the lock post 658 toward the first end 662 and into engagement with the cable plate 616.

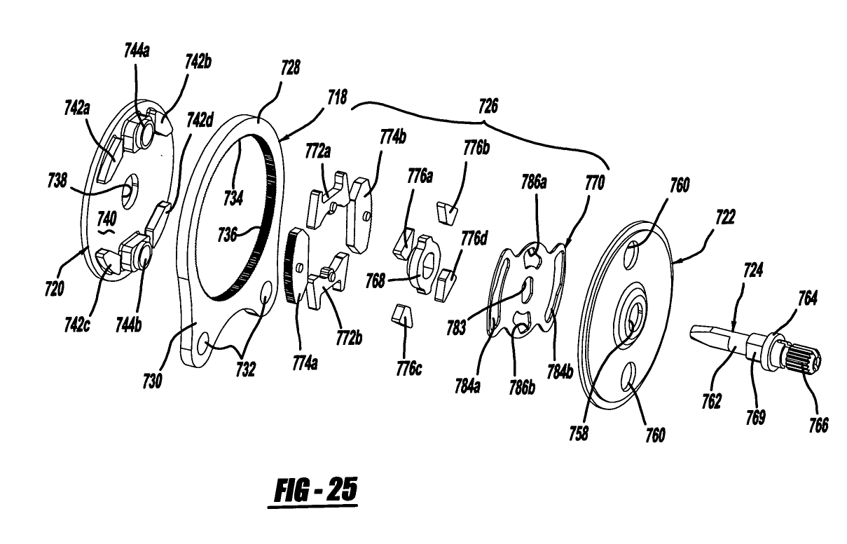

With reference to FIGS. 20-24, the actuation mechanism 610 is shown incorporated into the seat adjustment mechanism 10. The seatback frame 12 is positionable relative to the seat bottom frame 14 in a plurality of recline positions and is also positionable in a fold-flat position (i.e., the seatback frame 12 is folded against, and is substantially parallel to, the seat bottom frame 14) through use of the recliner mechanism 20, as previously discussed. The recliner mechanism 20 is remotely actuated through use of the actuation mechanism 610, which is mounted to the external structure (generally referred to as 680 in FIGS. 22-24). The external structure is a vehicle floor, sill, or interior wall, as previously discussed. The recliner mechanism 20 is in communication with the actuation mechanism 610 via tension member 620, which is any suitable flexible member such as a cable.

The actuation mechanism 610 is fixedly supported by the external structure and is in communication with the recliner mechanism 20 via tension member 620, as previously discussed. In addition, the actuation mechanism 610 is also in communication with a support link 28 associated with the seat adjustment mechanism 10. The support link 28 rotatably supports the seat bottom frame 14 and is rotatably supported by a lower bracket 684 that is fixedly attached to the external structure.

The support link 28 is rotatably attached to the release plate 614 at attachment aperture 640 by a pin 686. In this manner, as the support link 28 rotates relative to the lower bracket 684, a force is imparted on the release plate 614 through interaction between the pin 686 and projection 636.

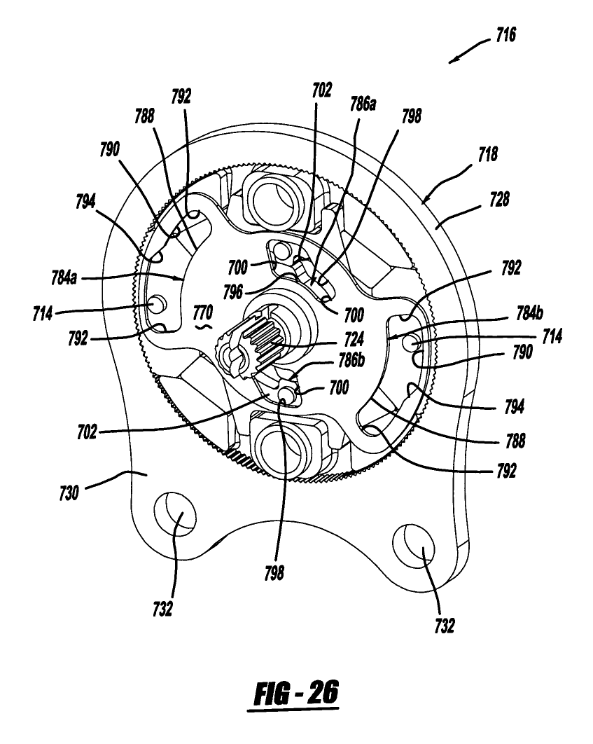

In operation, a force is applied to a floor latch mechanism 116 to thereby release the seat adjustment mechanism 10 and allow for pivotal movement of the seatback frame 12 and seat bottom frame 14 relative to the external structure and lower bracket 684. Once the floor latch mechanism 116 is released, the seatback frame 12 and seat bottom frame 14 begin to rotate in a direction labeled “X” in FIG. 23 relative to the support link 28. It should be noted that at this point, the lock mechansim 618 of the actuation mechanism 610 is in a locked state, thereby preventing rotation of the cable plate 616 relative to the housing 612.

As the seatback frame 12 and seat bottom frame 14 rotate in the X direction, a tensile force is applied to the tension member 620 as the cable plate 616 is prevented from rotating relative to the housing 612 due to the interaction between the lock mechansim 618 and the cable plate 616. In other words, as the recliner mechanism 20 rotates with the seatback frame 12 and seat bottom frame 14 in the X direction, the recliner mechanism 20 is caused to move farther away from the actuation mechanism 610. Movement of the recliner mechanism 20 relative to the actuation mechanism 610 causes the tension member 620 to experience a tensile force, thereby causing the tension member 620 to wrap around a body 642 of the cable plate 616 (FIG. 23).

The support link 28 rotates in the X direction upon sufficient rotation of the seatback frame 12 and seat bottom frame 14. Rotation of the support link 28 in the X direction is transmitted to the release plate 614 through interaction between the projection 636 and pin 686. Specifically, when the support link 28 rotates in the counterclockwise direction relative to the view shown in FIG. 21, the release plate 614 is similarly caused to rotate.

Sufficient rotation of the seatback frame 12, seat bottom frame 14, and recliner mechanism 20 in the counterclockwise direction causes the tension member 620 to experience a large enough force to release the recliner mechanism 20 and permit rotation of the seatback frame 12 relative to the seat bottom frame 14.

Once the seatback frame 12 is free to rotate relative to the seat bottom frame 14 (i.e., the recliner mechanism 20 is released), the actuation mechanism 610 can release tension in the tension member 620 to allow the recliner mechanism 20 to relock the seatback frame 12 relative to the seat bottom frame 14 once the seatback frame 12 achieves a fold-flat position. As can be appreciated, if the tension member 620 continues to impart a tensile force on the recliner mechanism 20, the recliner mechanism 20 will remain in the unlocked state and will not be able to re-lock the seatback frame 12 relative to the seat bottom frame 14 once in the fold-flat position. Therefore, the actuation mechanism 610 must release the tension applied to the tension member 620 once the recliner mechanism 20 has released the seatback frame 12 for rotation relative to the seat bottom frame 14.

The release plate 614 is designed such that sufficient rotation of seat adjustment mechanism 10 in the X direction causes the release plate 614 to rotate and engage the lock post 658 to thereby move the lock post 658 against the bias of springs 660, generally from the first end 662 of slots 626 to the second end 664 of slots 626.

Sufficient rotation of the release plate 614 causes the lock post 658 to disengage the cable plate 616 and permit the coil spring 650 to rotate the cable plate 616 relative to the housing 612. Rotation of the cable plate 616 essentially unwinds the tension member 620 from the plate 616, thereby releasing the tensile force applied to the tension member 620. In other words, once the recliner mechanism 20 is released, the release plate 614 permits rotation of the cable plate 616 to thereby provide slack in the tension member 620.

The slack afforded the tension member 620 allows the recliner mechanism 20 to relock once the seatback frame 12 achieves a fully folded-flat position. Therefore, the slack in the tension member 620 essentially allows the recliner mechanism 20 to hold the seatback frame 12 in the folded-flat state until the recliner mechanism 20 is released once again.

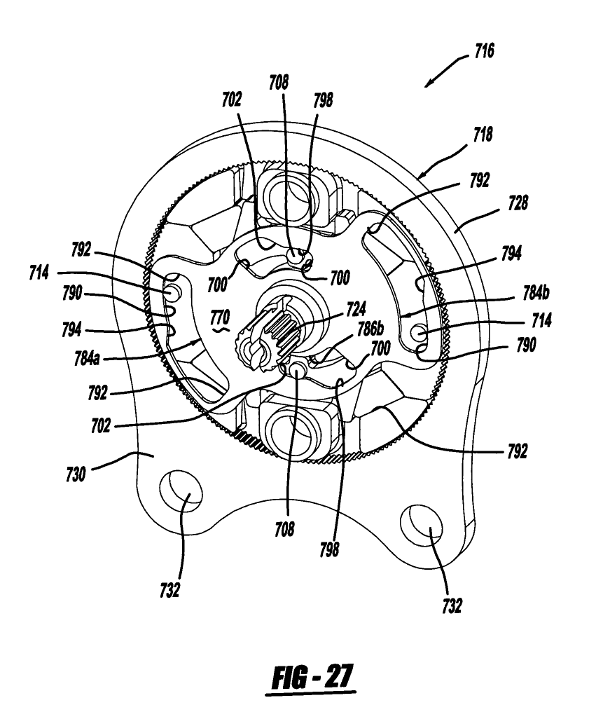

The actuation mechanism 610 resets upon return of the seat adjustment mechanism 10 to a usable position. Specifically, when the seat adjustment mechanism 10 is rotated from the fully dumped and stowed position (FIG. 24) to a usable position (FIG. 22), rotation of the support link 28 in the clockwise direction relative to the view shown in FIG. 21 causes concurrent rotation of the release plate 614 in the clockwise direction. Sufficient rotation of the release plate 614 in the clockwise direction causes the post 644 to engage the release plate 614, thereby causing the cable plate 616 to rotate against the bias of coil spring 650 and in the clockwise direction with the release plate 614.

Sufficient rotation of the cable plate 616 in the clockwise direction allows provides sufficient clearance for the springs 660 to once again bias the lock post 658 toward the first end 662 of slots 626. Once the lock post 658 is at the first end 662 of the slots 626, the actuation mechanism 610 is locked and the cable plate 616 is prevented from rotating relative to the housing 612.

As described, the actuation mechanism 610 can work in conjunction with the seat adjustment mechanism 10 to both the recliner mechanism 20 and allow the seatback frame 12 to fold-flat relative to the seat bottom frame 14 through operation of a single release mechanism 130. Furthermore, the actuation mechanism 610 allows the recliner mechanism 20 to relock once the seatback frame 12 is sufficiently parallel to the seat bottom frame 14 by releasing a tensile force applied to a tension member 620 disposed generally between the actuation mechanism 610 and the recliner mechanism 20.

The recliner mechanism 20 is actuable to selectively pivot and lock the seatback frame 12 in a plurality of positions relative to the seat bottom frame 14. The recliner mechanism 20 is preferably of the type disclosed in assignee's commonly-owned U.S. Provisional Patent Application No. 60/598,545, filed Aug. 3, 2004, the disclosure of which is incorporated herein by reference. While the recliner mechanism 20 will be described hereinafter as being a manual recliner mechanism, a powered recliner mechanism could alternatively be used.

FIGS. 25-31 depict the recliner mechanism 20 including a housing plate 718, a back plate 720, a cover plate 722, a pivot pin 724, and a locking mechanism 726. The housing plate 718 includes a housing portion 728 and a flange portion 730. The flange portion 730 includes a pair of fastener bores 732 adapted to receive a pair of fasteners 731 and fit the recliner mechanism 720 to the seat bottom frame 14. The housing portion 728 includes a central aperture 734 defining a plurality of internal teeth 736.

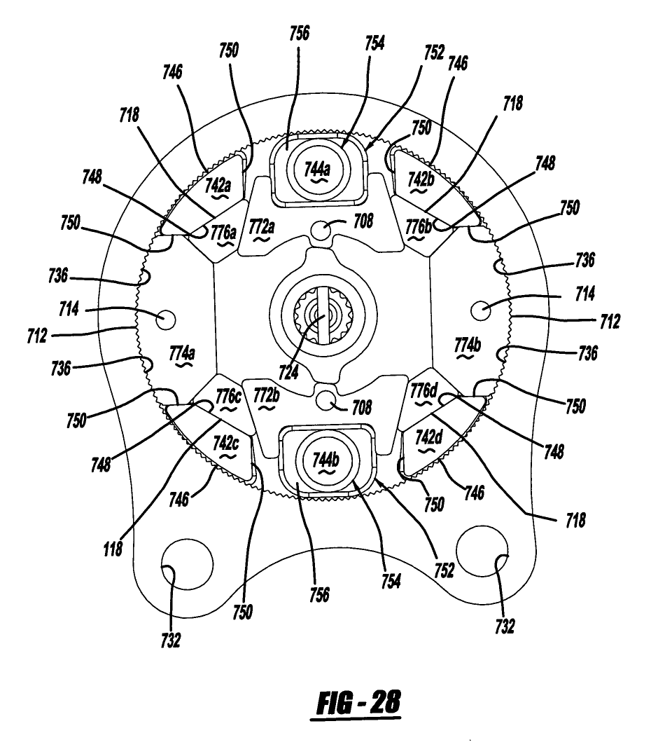

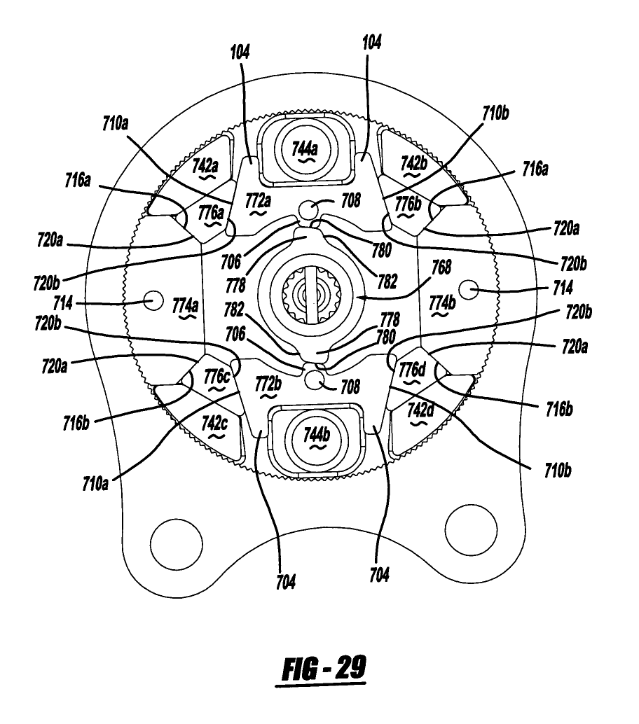

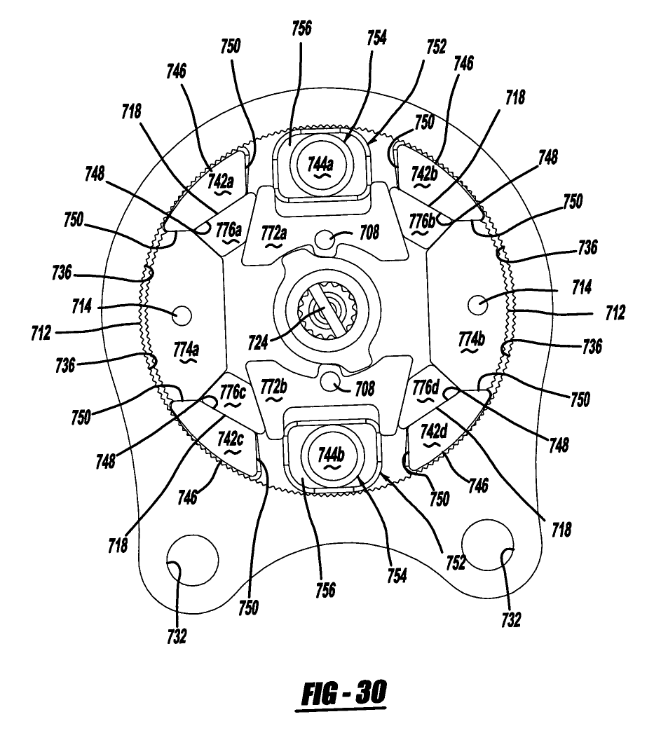

The back plate 720 includes a pivot aperture 738 and an inner surface 740. The inner surface 740 defines a plurality of slide bosses 742 and a pair of guide bosses 744. The plurality of slide bosses 742 includes a first slide boss 742a, a second slide boss 742b, a third slide boss 742c, and a fourth slide boss 742d. As best illustrated in FIGS. 27 and 28, each slide boss 742 includes a semi-circumferential surface 746, a sliding surface 748, and a pair of radial surfaces 750. The pair of radial surfaces 750 extend between the semi-circumferential surfaces 746 and sliding surfaces 748. The pair of guide bosses 744 include a first guide boss 744a and a second guide boss 744b, each including a body portion 752 and a post portion 754. The body portion 752 includes a shoulder surface 756. The post portion 754 is substantially cylindrical and extends axially away from the shoulder surface 756 of the body portion 752.

The cover plate 722 includes substantially cylindrical plates having a central aperture 758 and a pair of post apertures 760. As shown in FIG. 26, the pair of post apertures 760 receive the post portions 754 of the guide bosses 744 to maintain the rotational disposition of the cover plate 722 relative to the back plate 720.

The pivot pin 724 includes a tenon portion 762, a shoulder portion 764, and a toothed portion 766. The tenon portion 762 includes a pair of diametrically opposed flat surfaces 769. The pivot pin 724 extends through the central aperture 758 of the cover plate 722 and the pivot aperture 738 of the back plate 720. The shoulder portion 764 abuts the cover plate 722 to maintain the axial disposition of the pivot pin 724. The toothed portion 766 is adapted to be engaged by an actuation lever (not shown), which is in communication with tension member 620 (described above with respect to actuation mechanism 610).

The locking mechanism 726 includes a locking cam 768, a release cam 770, a pair of wedges 772, a pair of pawls 774, and a plurality of slides 776. The locking mechanism 726 is actuable to selectively engage the recliner mechanism 720 to prevent relative rotation of the back plate 720, cover plate 722, and pivot pin 724 relative to the housing plate 718.

The locking cam 768 is a generally annular member defining a pair of radial arms 778. The radial arms 778 each include a locking surface 780 and a thrust surface 782. As illustrated in FIGS. 24-27, the release cam 770 is a generally planar member defining a central aperture 783, a pair of major peanut slots 784, and a pair of minor peanut slots 786. The pair of major peanut slots 784 includes a first major peanut slot 784a and a second major peanut slot 784b. The major peanut slots 784 each include an inner edge 788, an outer edge 790, and opposing radial edges 792. The outer edges 790 include a radially converging portion 794. The pair of minor peanut slots 786 includes a first minor peanut slot 786a and a second minor peanut slot 786b. The minor peanut slots 786 each include an inner edge 796, an outer edge 798, and opposing radial edges 800. The outer edge 798 includes a radially converging portion 802. The minor peanut slots 786 are generally smaller than the major peanut slots 784.

As illustrated in FIGS. 25 and 26, the pair of wedges 772 includes a first wedge 772a and a second wedge 772b. The wedges 772 each include a pair of radial arms 804, a radial boss 806, an axial boss 808, a first driving surface 810a, and a second driving surface 810b. The pair of pawls 774 includes a first pawl 774a and a second pawl 774b. The pawls 774 each include a toothed semi-circular surface 812, an axial boss 814, a first driven surface 816a, and a second driven surface 816b. The plurality of slides 776 includes a first slide 776a, a second slide 776b, a third slide 776c, and a fourth slide 776d. The slides 776 each include a sliding surface 818, a first radially converging surface 820a, and a second radially converging surface 820b.

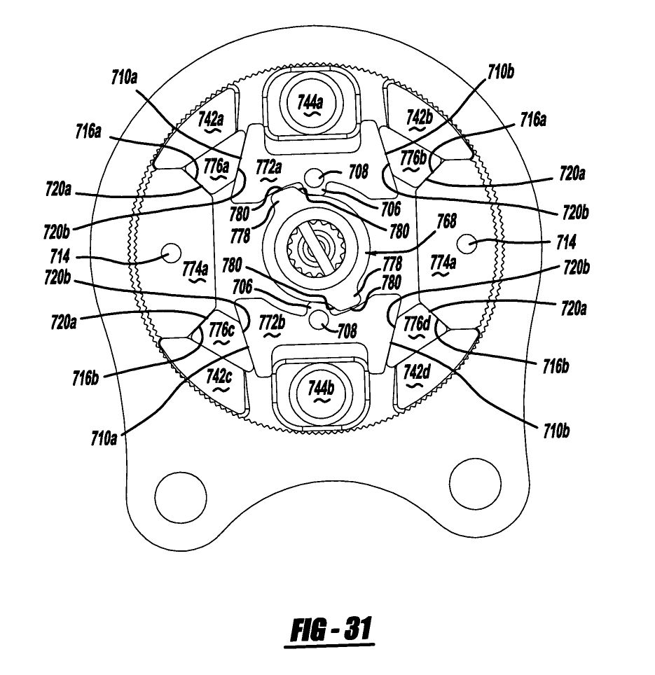

FIGS. 28-31 depict the recliner mechanism 720 assembled with the cover plate 722 and release cam 770 removed to expose the locking mechanism 726. It should be understood that for the purposes of clarity, FIGS. 28 and 29 are duplicates of each other except for the reference numerals provided therein. Likewise, FIGS. 30 and 31 are duplicates of each other except for the reference numerals provided therein.

The locking cam 768 is disposed on the pivot pin 724. The first wedge 772a is slidably disposed on the inner surface 740 of the back plate 720 generally between the locking cam 768 and the first guide boss 744a. The second wedge 772b is slidably disposed on the inner surface 740 of the back plate 720 generally between the locking cam 68 and the second guide boss 744b.

The first slide 776a is slidably disposed on the inner surface 740 of the back plate 720 generally adjacent to the first slide boss 742a. The second radially converging surface 820b of the first slide 776a slidably engages the first driving surface 810a of the first wedge 772a. The sliding surface 818 of the first slide 776a slidably engages the sliding surface 748 of the first slide boss 742a. The second slide 776b is disposed on the inner surface 740 of the back plate 720 generally adjacent to the second slide boss 742b. The second radially converging surface 820b of the second slide 776b slidably engages the second driving surface 810b of the first wedge 772a. The sliding surface 818 of the second slide 776b slidably engages the sliding surface 748 of the second slide boss 742b. The third slide 776c is disposed on the inner surface 740 of the back plate 720 generally adjacent to the third slide boss 742c. The second radially converging surface 820b of the third slide 776c slidably engages the first driving surface 810a of the second wedge 772b. The sliding surface 818 of the third slide 776c slidably engages the sliding surface 748 of the third slide boss 742c. The fourth slide 776d is disposed on the inner surface 740 of the back plate 720 generally adjacent to the fourth slide boss 742d. The second radially converging surface 820b of the fourth slide 776d slidably engages the second driving surface 810b of the second wedge 772b. The sliding surface 818 of the fourth slide 776d slidably engages the sliding surface 748 of the fourth slide boss 742d.

The first pawl 774a is disposed on the inner surface 740 of the back plate 720 generally between the first and third slide bosses 742a, 742c. The first driven surface 816a of the first pawl 774a slidably engages the first radially converging surface 820a of the first slide 776a. The second driven surface 816b of the first pawl 774a slidably engages the first radially converging surface 820a of the third slide 776c. The second pawl 774b is disposed on the inner surface 740 of the back plate 720 generally between the second and fourth slide bosses 742b, 742d. The first driven surface 816a of the second pawl 774b slidably engages the first radially converging surface 820a of the second slide 776b. The second driven surface 816b of the second pawl 774b slidably engages the first radially converging surface 820a of the fourth slide 776d.

As best seen in FIGS. 26 and 27, the central aperture 783 of the release cam 770 is received on the tenon portion 762 of the pivot pin 724. The central aperture 783 engages the flat surfaces 769 to rotationally interconnect the release cam 770 and pivot pin 724. The first major peanut slot 784 receives the axial boss 814 of the first pawl 774a. The second major peanut slot 784b receives the axial boss of the second pawl 774b. The first minor peanut slot 786a receives the axial boss 808 of the first wedge 772a. The second minor peanut slot 786b receives the axial boss 808 of the second wedge 772b.

FIGS. 26 and 28-29 depict the recliner mechanism 20 having the locking mechanism 726 in an engaged position. The axial bosses 808 of the pair of wedges 772 are disposed in the minor peanut slots 786 at a location displaced counterclockwise from the radially converging portion 802 of the outer edge 98. The axial bosses 914 of the pair of pawls 774 are disposed within the major peanut slots 784 at a location displaced counterclockwise from the radially converging portions 794 of the outer edge 790. The wedges 772 engage the guide bosses 744 such that radial arms 804 receive the body portions 752. The toothed semi-circular surfaces 812 of the pawls 774 meshingly engage the internal teeth 736 of the central aperture 734 of the housing plate 718.

To disengage the recliner mechanism 20, the lever is pivoted in a counterclockwise direction relative to the housing plate 18 due to the rotational force exerted thereon by tension member 620 through rotation of the recliner mechanism 20 relative to the actuation mechanism 610, as will be described further below. This pivots the locking cam 768 counterclockwise such that the locking surfaces 780 of the radial arms 778 disengage the radial bosses 806 on the pair of wedges 772. The release cam 770 also pivots counterclockwise. The radially converging portions 794 of the outer edges 790 of the pair of major peanut slots 784 engage the axial bosses 814 on the pair of pawls 774. The radially converging portions 802 of the outer edges 798 of the minor peanut slots 786 engage the axial bosses 808 on the pair of wedges 772. Such engagement causes inward radial displacement of the pair of wedges 772 and the pair of pawls 774 to the position illustrated in FIGS. 28-29, thereby disengaging the recliner mechanism 20.

To re-engage the recliner mechanism 20, the lever is pivoted in a clockwise direction relative to the housing plate 718. This pivots the locking cam 768 clockwise such that the thrust surfaces 782 of the radial arms 778 slidingly engage the radial bosses 806 on the pair of wedges 772. This displaces the wedges 772 radially outward relative to the locking cam 768 until the locking surfaces 780 reach the radial bosses 806. The first driving surface 810a of the first wedge 772a slidably engages and drives the second radially converging surface 820b of the first slide 776a. The first radially converging surface 820a of the first slide 776a slidably engages and drives the first driven surface 816a of the first pawl 774a. The first driving surface 810a of the second wedge 772b slidably engages and drives the second radially converging surface 820b of the third slide 776c. The first radially converging surface 820a of the third slide 776c slidably engages and drives the second driven surface 816b of the first pawl 774a. This displaces the first pawl 774a radially outward such that the toothed semi-circular surface 812 lockingly engages the plurality of internal teeth 736 on in the central aperture 734 of the housing plate 718.

Concurrently, the second driving surface 810b of the first wedge 772a slidably engages and drives the second radially converging surface 820b of the second slide 776b. The first radially converging surface 820a of the second slide 776b slidably engages the first driven surface 816a of the second pawl 774b. The second driving surface 810b of the second wedge 772b slidably engages the second radially converging surface 820b of the fourth slide 776d. The first radially converging surface 820a of the fourth slide 776d slidably engages the second driven surface 816b of the second pawl 774b. This displaces the second pawl 774a radially outward such that the toothed semi-circular surface 812 lockingly engages the plurality of internal teeth 736 on in the central aperture 734 of the housing plate 718. Therefore, it should be appreciated that the present invention provides a recliner mechanism 20 having a plurality of pawls 774 operable to lockingly engage a housing plate 718. This provides for a robust recliner mechanism 20 capable of withstanding large moments inflicted by a vehicle seatback.

The headrest assembly 22 is supported by the seatback frame 12 generally opposite from the recliner mechanism 20, as best shown in FIG. 1. The headrest assembly 22 is preferably of the type disclosed in assignee's commonly-owned U.S. patent application Ser. No. 10/992,599, filed Nov. 18, 2004, the disclosure of which is incorporated herein by reference.

The headrest assembly 22 includes a housing 912, a head support 914, a rail assembly 916, an automated actuator 918, and a lock member 920. The rail assembly 916 is adjustably mounted to the housing 912 to allow the headrest assembly 22 to move between a use position and a stow position. The lock member 920 selectively engages and disengages one of the rails 956 of rail assembly 916 in order to allow the headrest assembly 22 to move between positions.

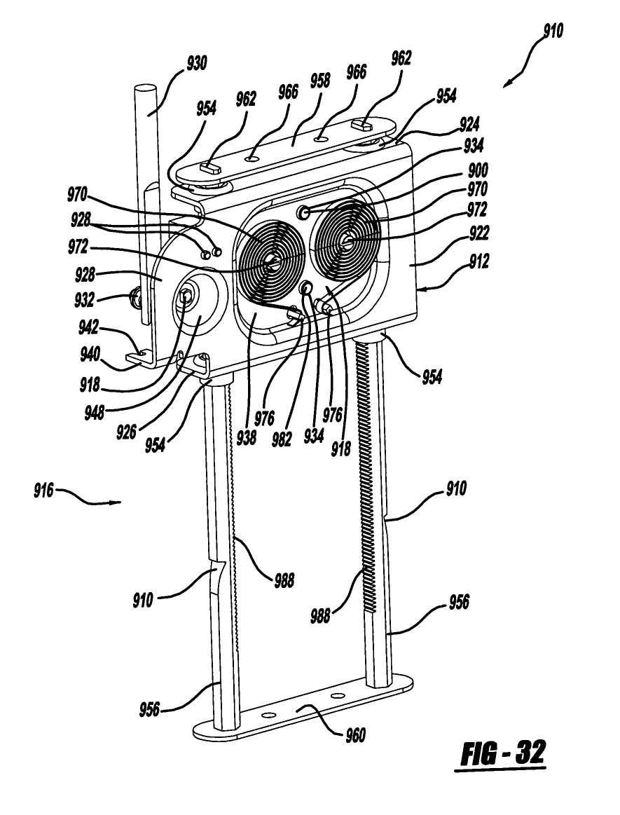

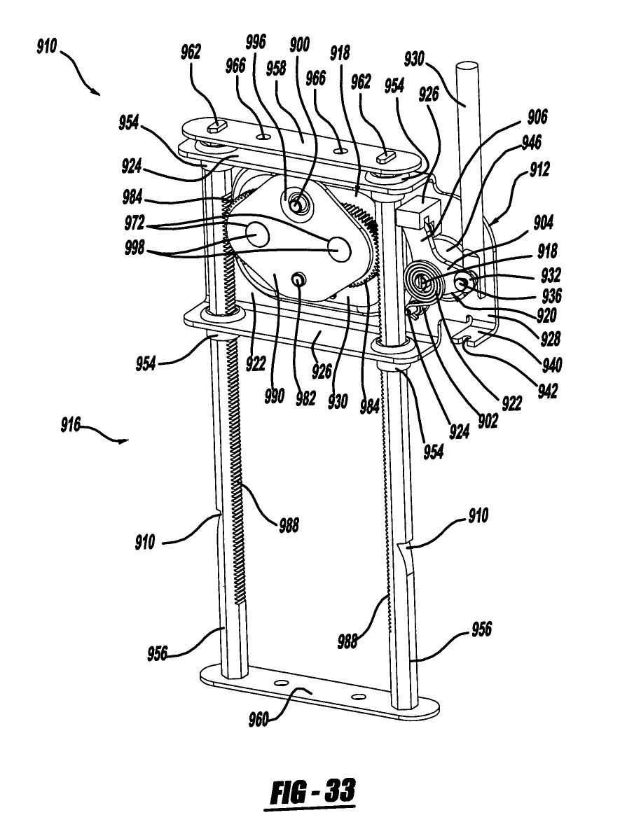

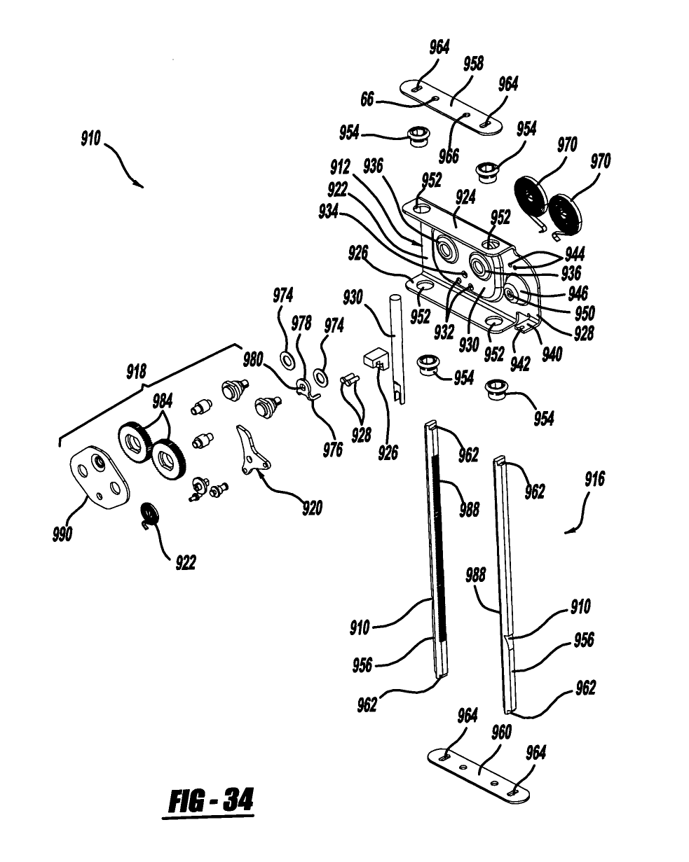

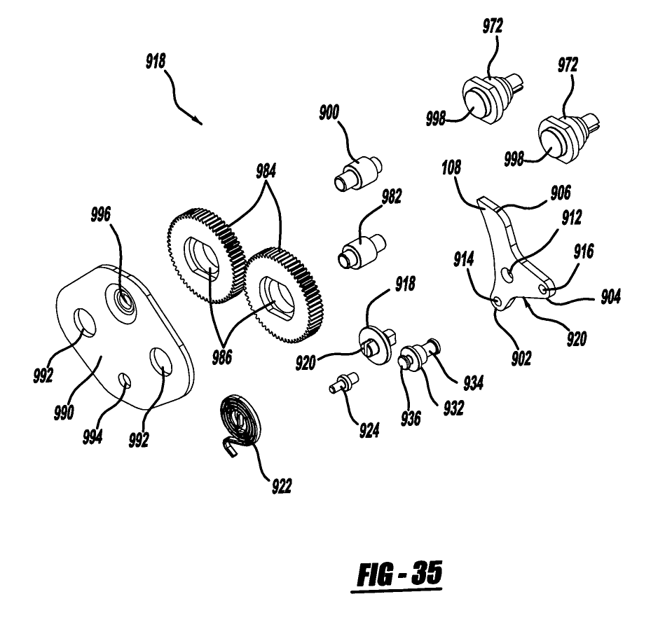

With particular reference to FIGS. 32-34, the housing 912 is shown to have a main body 922, first and second flanges 924, 926, and an extension 928. The main body 922 extends between the first and second flanges 924, 926 and contains an extrusion 930 extending outward from the surface of the main body 922 in the same direction as the first and second flanges 924, 926. The extrusion 930 includes two apertures 932 for receiving posts, two apertures 934 for receiving pegs (the second aperture of which cannot be seen in FIGS. 33 and 34, but is the aperture through which a second peg 1000 extends as best seen in FIG. 32), and two apertures 936 for coupling components of automated actuator 918, all of which extend through extrusion 930. The periphery of apertures 936 extend beyond extrusion 930 in the same direction as the first and second flanges 924, 926 so that the periphery is not flush with extrusion 930. On the opposite side of main body 922 from extrusion 930, a well 938 results from extrusion 930.

First and second flanges 924, 926 extend generally perpendicular to the plane of main body 922 and include rail apertures 952 positioned to adjustably mount rail assembly 916 to housing 912. Camming knobs 954 are disposed in each of the four rail apertures 952. Extension 928 extends laterally from main body 922 beyond the lengths of first and second flanges 924, 926, and includes a receiving tab 940, which subsequently includes a receiving cutout 942. Extension 928 includes a pair of apertures 944 and a boss 946. On the opposite side of extension 928 from boss 946, a well 948 results from extruding boss 946. An aperture 950 for receiving lock member 920 extends through boss 946 to the side of well 948.

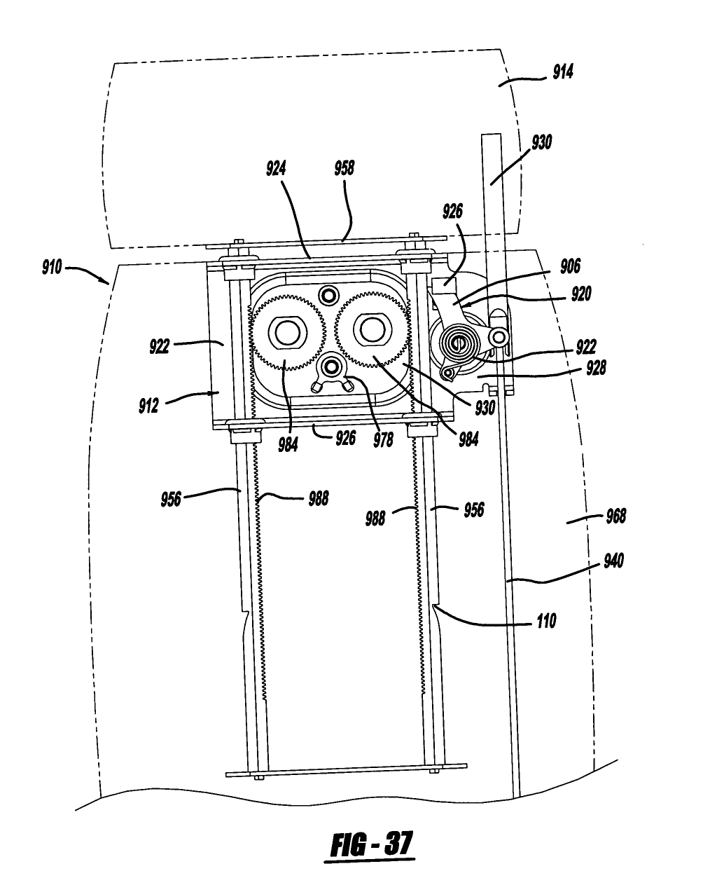

The rail assembly 916 includes rails 956, top end plate 958, and bottom end plate 960. The rails 956 include rail ends 962 keyed to fit in keyed apertures 964 of top end plate 958 and bottom end plate 960. Both the top end plate 958 and bottom end plate 960 also include seat apertures 966 for attaching the headrest assembly 22 to the seat adjustment mechanism 10 generally at seatback frame 12. The top end plate 958 attaches to head support 914 (shown in FIGS. 36-38) through seat apertures 966 and bottom end plate 960 is mounted to a seatback 968 (also shown in FIGS. 36-38).

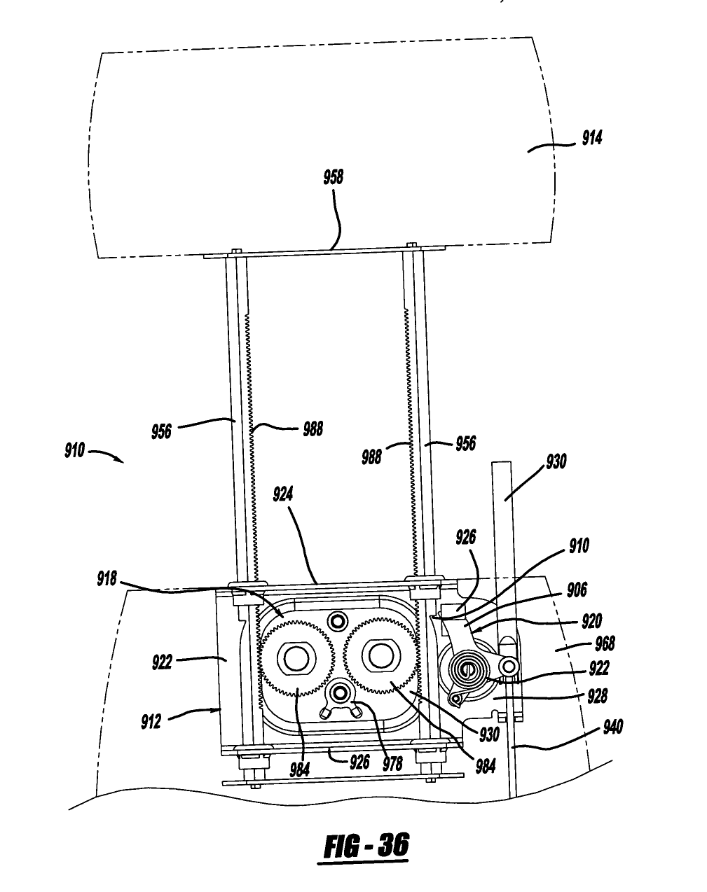

With reference to FIGS. 34-35, the automated actuator 918 includes a pair of springs 970 located adjacent the well 938 of main body 922 and is supported by bolts 972 that are both received through apertures 936 of extrusion 930 and extend through the centers of the coils of springs 970. A pair of washers 974 are positioned between bolts 972 and apertures 936. Outer ends of springs 970 are secured by a pair of posts 976 (both of which are visible in FIG. 32), which are part of a clip 978 whose clip face 980 is laterally aligned with and secured to extrusion 930. The clip face 980 is secured to extrusion 930 by a first peg 982 that is received by aperture 934 adjacent apertures 932.

The springs 970 are coupled to respective gears 984 via bolts 972. More specifically, gears 984 have apertures 986 that spring bolts 972 pass through before entering apertures 936 to support springs 970, thus operably coupling the gears 984 with the springs 970. Gears 984 engage rail assembly 916 via teeth 988 disposed along rails 956. Additionally, a cover plate 990 includes two larger apertures 992 for receiving the bolts 972 that couple springs 970 to gears 984, a smaller aperture 994 for receiving the first peg 982, a recessed aperture 996 for receiving a second peg 1000, and is attached to main body 922. More specifically, faces 998 of bolts 972 are received by larger apertures 992, first peg 982 is received by both smaller aperture 994 and the aperture 934 adjacent apertures 932, and second peg 1000 is received by both recessed aperture 996 and the aperture 34 adjacent first flange 924.

The lock member 920 generally includes three lobes; two shorter lobes 1002, 1004, and a longer lobe 1006. Longer lobe 1006 includes a tapered end 1008 operable to engage a notch 1010 on one of the rails 956. Shorter lobes 1002, 1004 and longer lobe 1006 are approximately equidistantly spaced around a center aperture 1012 extending through lock member 920. Each shorter lobe 1002, 1004 includes an aperture extending through lock member 920: the shorter lobe 1002 includes an aperture 1014 for receiving a post and the shorter lobe 1004 an aperture 1016 for receiving a manual actuator 1030. The longer lobe 1006 of lock member 920 is guided by guide 1026, which is attached to extension 928 by two guide pins 1028 extending through apertures in guide 1026 as well as through apertures 944 of extension 928. A post 1018 couples lock member 920 to boss 946 by extending through center aperture 1012 and the aperture 950 located through boss 946. An end 1020 of spring post 1018 remains adjacent the boss 946 of extension 928 in order to support a spring 1022 whose end is anchored by post 1024, which is fixed to lock member 920 through aperture 1014.

Notch 1010 is located on rail 956 to allow the rail assembly 916 to be moved to a first use position remote from the stow position. Intermediate use positions may also be provided between the first use position and the stow position by providing additional notches 1010 or any other manner known in the art. In the use position, the tapered end 1008 of longer lobe 1006 engages rail 956 at notch 1010 under the bias of spring 1022. As lock member 920 is rotated against the bias of spring 1022, i.e., in the clockwise direction relative to the view shown in FIG. 36, tapered end 1008 disengages from notch 1010 of rail 956, which causes gears 984 to move under the bias of springs 970. The movement of gears 984 is biased such that when they move, rail assembly 916 moves to return the headrest assembly 22 to a stow position. More specifically, gears 984 engage teeth 988 of rails 956 to move the rail assembly 916 toward seatback 968. Once the tapered end 1008 is initially disengaged from notch 1010 of rail 956 and the gears 984 begin to rotate, the tapered end 1008 may return to its bias position and slide along rail 956 without impeding the movement of rail assembly 916.

With particular references to FIGS. 34-36, one way lock member 920 can be rotated against the bias of spring 1022 as described above is through the use of manual actuator 1030, which is connected to shorter lobe 1004 through aperture 1016. A pin 1032 is connected to lock member 920 through aperture 1016 and receives manual actuator 1030 by joining manual actuator 1030 to pin end 1034. When the headrest assembly 22 is in the use position, the tapered end 1008 of longer lobe 1006 engages notch 1010 of rail 956 under the bias of spring 1022. By moving manual actuator 1030 in the direction of arrow A in FIG. 36, lock member 920 is rotated against the bias of spring 1022, i.e., in the clockwise direction relative to the view shown in FIG. 36. In turn, tapered end 1008 disengages rail 956 at notch 1010 and gears 984 subsequently move under the bias of springs 970. The movement of gears 984 causes the headrest assembly 22 to return to the stow position. Once the tapered end 1008 is initially disengaged from notch 1010 of rail 956 and the gears 984 begin to rotate, the manual actuator 1030 may return to its initial position and the tapered end 1008 will subsequently slide along rail 956 without impeding movement of rail assembly 916 to the stow position.

Lock member 920 may also be actuated by the recliner mechanism 20 operable to adjust the seatback frame 12 relative to the seat bottom frame 14. Alternatively, lock member 920 may be actuated by a solenoid (not shown) to allow for powered operation of the headrest assembly 22. In a manual operation, the recliner mechanism 20 interacts with the headrest assembly 22 through a cable 1040 coupled to lock member 920 through pin 1032, which includes a pin head 1036 opposite to pin end 1034. More particularly, one end of cable 1040 is received through cutout 942 in receiving tab 940 and connected to lock member 920 via pin head 1036, while the opposite end of cable 1040 is connected to the recliner mechanism 20. As recliner mechanism 20 is actuated to adjust the seatback frame 12, cable 1040 is manipulated. In this regard, the force associated with reclining the seatback frame 12 is transmitted to the headrest assembly 22 such that the lock member 920 engages and disengages rail 956. At the point that recliner mechanism 20 causes cable 1040 to become taut, cable 1040 pulls in the direction of Arrow A in FIG. 36, causing lock member 920 to rotate against the bias of spring 1022, i.e., in the clockwise direction relative to the view shown in FIG. 36, and initiating displacement of headrest assembly 22 from its use position. Specifically, the tapered end 1008 of longer lobe 1006 disengages from rail 956 at notch 1010 and allows gears 984 to move under the bias force of springs 970, causing the headrest assembly 22 to return to the stow position as described above. Once the tapered end 1008 is initially disengaged from the rail 956 at notch 1010 and the gears 984 begin to rotate, the tapered end 1008 may engage rail 956 away from notch 1010 and subsequently slide along rail 956 without impeding the movement of rail assembly 916.

With particular reference to FIGS. 34 and 36-38, head support 914 attaches to top end plate 958 through seat apertures 966. Housing 912 is attached to a top portion of the seatback frame 12 such that first flange 924 of housing 912 is located near the top of the seatback frame 12. Subsequently, the majority of housing 912 is situated within the seatback frame 12. As the headrest assembly 22 is moved from its stow position to its use position by moving head support 914 away from the seatback frame 12, rails 956 extend from the seatback frame 12. The seat operator may manually move head support 914 to a desired use position relative to the seatback frame 12, such as the first use position wherein tapered end 1008 of longer lobe 1006 engages rail 956 at notch 1010.

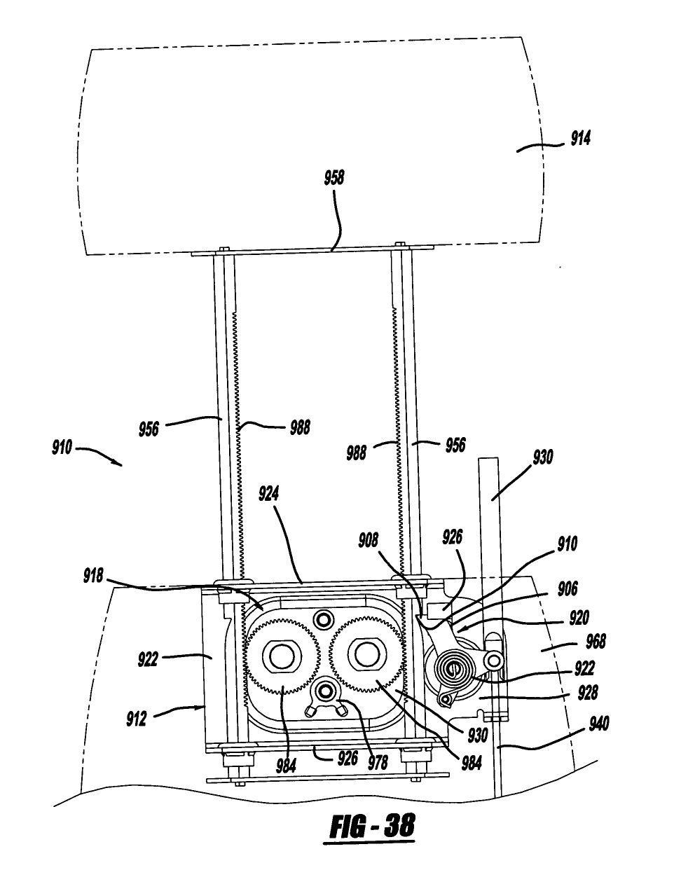

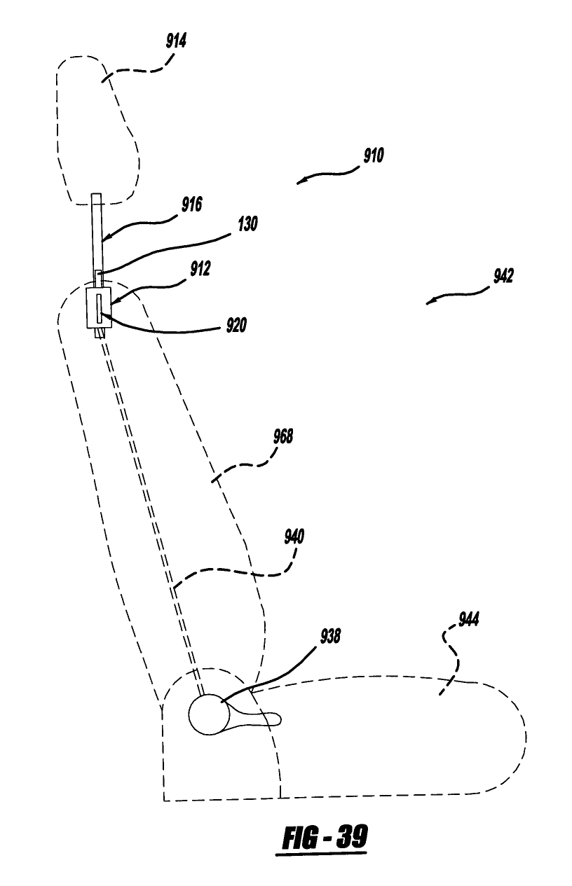

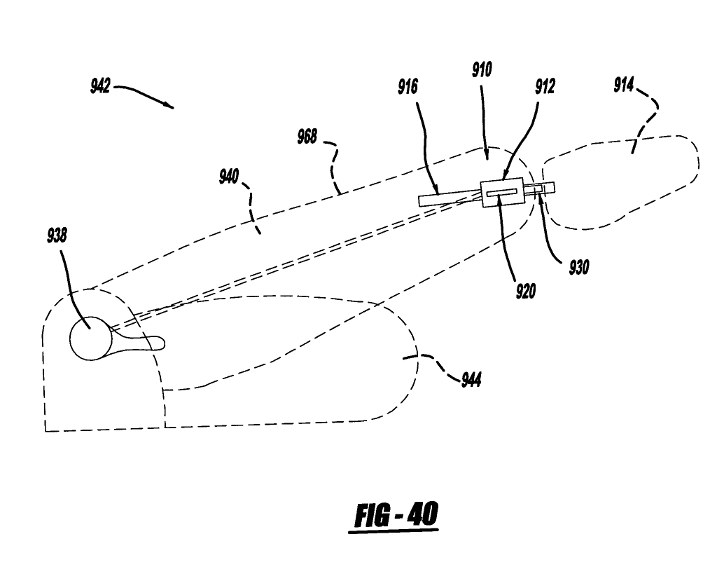

In order to move headrest assembly 22 from a use position to a stow position, a force in the direction of arrow A in FIG. 36 is applied either via the manual actuator 1030 or the cable 1040 as described above. Either method causes the lock member 920 to rotate against the bias of spring 1022, i.e., in the clockwise direction relative to the view shown in FIG. 36. This rotation of lock member 920 causes tapered end 1008 of longer lobe 1006 to disengage from rail 956 at notch 1010. Upon disengagement, rails 956 slide in the direction of arrow A toward the stow position under the force of springs 970 acting on gears 984. Specifically, gears 984 and springs 970 are coupled and bias so that headrest assembly 22 automatically returns to the stow position upon the disengagement of tapered end 1008 from rail 956 at notch 1010. FIG. 36 shows the headrest assembly 22 when lock member 920 is disengaged from rail 956 to allow headrest assembly 22 to move from its use position to its stow position. FIG. 37 shows headrest assembly 22 in a stow position, wherein gears 984 are coupled with rails 956 at the top-most point of rails 956. FIG. 38 shows headrest assembly 22 in a use position, wherein tapered end 1008 of lock member 920 is engaged with notch 1010 of rail 956.

In one embodiment, the lock member 920 is in mechanical communication with recliner mechanism 20 via cable 1040. The first end of cable 1040 is fixably attached to recliner mechanism 20 while the second end of cable 1040 is attached to pin head 1036, which resultantly causes cable 1040 to be fixably attached to lock member 920 via pin head 1036. Thus, cable 1040 is operable to apply a force on lock member 920 via pin head 1036 to disengage the tapered end 1008 (best shown in FIG. 35) of lock member 920 from rail 956 of rail assembly 916. The resultant force causes lock member 920 to rotate in the clockwise direction relative to the view shown in FIG. 36.

When the seatback frame 12 is in a fully forward or upright position, headrest assembly 22 is similarly in a fully upright position such that the tapered end 1008 of lock member 920 is engaged with notch 1010 of rail 956. To recline the seatback frame 12 relative to the seat bottom frame 14, a force is automatically applied to the recliner mechanism 20 through release of the floor latch mechanism 116 such that the recliner mechanism 20 disengages the seatback frame 12. Once the recliner mechanism 20 has sufficiently disengaged the seatback frame 12, a force may be applied to the seatback frame 12 to thereby rotate the seatback frame 12 into a dumped position, such that the seatback frame 12 is substantially parallel to the seat bottom frame 14. The force applied to dump the seatback frame 12 relative to the seat bottom frame 14 causes a tensile force to be concurrently applied to cable 1040. This tensile force is generated due to the relationship between cable 1040, recliner mechanism 20, and the manual actuator pin head 1036 that transmits the force to lock member 920.

The tensile force of cable 1040 causes a force in the direction of arrow A in FIG. 36 to rotate lock member 920 against the bias of spring 1022, i.e., the clockwise direction relative to the view shown in FIG. 36, leading the tapered end 1008 of lock member 920 to disengage from rail 956 at notch 1010. Upon disengagement, rails 956 slide in the direction of arrow A toward the stow position under the force of springs 970 acting on gears 984. Specifically, gears 984 and springs 970 are coupled and bias so that headrest assembly 22 automatically returns to the stow position upon the disengagement of tapered end 1008 from notch 1010 of rail 956.

Once the seatback frame 12 has been moved to the stow position and the recliner mechanism 20 has locked the seatback frame 12 relative to the seat bottom frame 14, cable 1040 loses its tensile force and spring 1022 once again biases lock member 920 in the counterclockwise direction relative to the view shown in FIG. 36 until lock member 920 engages rail 956 away from notch 1010. The headrest assembly 22 and the seat adjustment mechanism 10, each in their respective stow positions, is best seen in FIGS. 37 and 940.

Headrest assembly 22 may be returned to a stow position when both the headrest assembly 22 and the seat adjustment mechanism 10 are in the use position by manipulation of manual actuator 1o30, which rotates lock member 920 in a manner similar to cable 1040. By moving the manual actuator 1030 downward in the direction of arrow A in FIG. 36, a force is transmitted that causes lock member 920 to rotate against the bias of spring 1022, i.e., in the clockwise direction relative to the view shown in FIG. 36. Subsequently, the tapered end 1008 of lock member 920 disengages from rail 956 at notch 1010 and rails 956 slide in the direction of arrow A toward the stow position under the force of springs 970 acting on gears 984. Specifically, gears 984 and springs 970 are coupled and bias so that headrest assembly 22 automatically returns to the stow position upon the disengagement of tapered end 1008 from notch 1010 of rail 956. Seat assembly 1042 may subsequently be moved to its stow position by using the recliner mechanism 1038, as discussed above.

With particular reference to FIGS. 1-4, operation of the seat adjustment mechanism 10 will be described in detail. At the outset, its should be noted that the operation of the seat adjustment mechanism 10 will be described with reference to a single floor latch mechanism 116, recliner mechanism 20, and headrest mechanism 22, but the more than one of the respective mechanisms can be used with the seat adjustment mechanism 10 and that when one mechanism is released, all like mechanisms are also released. Such actuation of a plurality of like mechanisms is accomplished through use of linkages or tension members interconnecting the respective mechanisms.

FIGS. 1 and 2 depict the seat adjustment mechanism 10 in the use position. To position the seat adjustment mechanism 10 in the stowed position, a force is applied generally to the release mechanism 130 of the floor latch mechanism 116. As can be appreciated, release mechanism 130 may be disposed at any location proximate to the seat adjustment mechanism 10 as the force applied thereto is easily transmitted to the release cam 124 via a tension member, such as, but not limited to a cable (not shown). Once a sufficient force is applied to the release mechanism 130, the floor latch mechanism 116 is toggled from the latched state to the unlatched state, as previously discussed.

If the seat adjustment mechanism 10 includes a stow pivot assembly 316, the force applied to the release mechanism 130 must also be transmitted to the stow pivot assembly 316 to thereby permit rotation of the seatback frame 12 and seat bottom frame 14 relative to the external structure. The force can be transmitted via a mechanical link such as a tension member. However, if the seat adjustment mechanism 10 does not include a stow pivot 316, and only includes a pivot assembly 34, once the floor latch mechanism 116 is released, the seatback frame 12 and seat bottom frame 14 are permitted to rotate about pivot 34 relative to the external structure.

Sufficient rotation of the seatback frame 12 and seat bottom frame 14 relative to the external structure releases the recliner mechanism 20 and headrest mechanism 22. Specifically, the release cam 770 of the recliner mechanism 20 is tied to a tension member, such as, but not limited to, a cable (not shown) such that sufficient rotation of the seatback frame 12 relative to the seat bottom frame 14 releases the recliner mechanism 20 and permits rotation of the seatback frame 12 relative to the seat bottom frame 14. The lock member 920 of the headrest assembly 22 is similarly tied to a tension member, such as, but not limited to, a cable (not shown) such that sufficient rotation of the seatback frame 12 relative to the seat bottom frame 14 releases the headrest mechanism 22 into a stowed position.

It should be understood that while a manual recliner mechanism 20 and headrest assembly 22 are disclosed, that either, or both of, the recliner mechanism 20 and headrest assembly 22 could be powered systems controlled by the system controller 503. In such a system, once the button 501 is depressed (discussed above with respect to powered system 500), and the floor latch mechanism 116 is released, the system controller 503 could send an event message to the recliner mechanism 20 and/or headrest mechanism 22 to permit rotation of the seatback frame 12 relative to the seat bottom frame 14 and permit retraction of the headrest assembly 22 into the stowed (i.e., retracted) position.

Once the recliner mechanism 20 and headrest assembly 22 are released, continued rotation of the seatback frame 12 and seat bottom frame 14 relative to the external structure is permitted until the seatback frame 12 and seat bottom frame 14 move from the partially-stowed position (FIG. 3) to the fully-stowed position (FIG. 4). When in the fully-stowed position, the seat bottom frame 14 is substantially parallel to the external structure, and thus, creates a flat load floor, due generally to the weight of the seatback frame 12 and seat bottom frame 14. As described above, the powered system 500 may include a four-bar link system 24 and/or a linear recliner mechanism 26 to obtain a substantially flat load floor when the seatback frame 12 and seat bottom frame 14 are in the fully stowed position. However, when the seat adjustment mechanism includes primarily manual mechanisms, the weight of the seatback frame 12 and seat bottom frame 14 actually assists in maintaining the seatback frame 12 and seat bottom frame 14 in a generally parallel relationship relative to the external structure.

Once the seatback frame 12 and seat bottom frame 14 are in the fully-stowed position (FIG. 4), the actuation mechanism 610 acts on the tension member 620 disposed generally between the recliner mechanism 20 and the actuation mechanism 610 to thereby allow the recliner mechanism 20 to relock and prevent rotation of the seatback frame 12 relative to the seat bottom frame 14. In this manner, the seatback frame 12 and seat bottom frame 14 are essentially held in the fully-stowed position (FIG. 4) until the recliner mechanism 20 is released once again.

As described, the seat adjustment mechanism 10 permits stowing of a seatback frame 12 and seat bottom frame 14 through actuation of a single release mechanism 130 or single button 501 (i.e., for the powered system 500). The seat adjustment mechanism 10 is configured such that the seatback frame 12 can operably support a seatback of a seat while the seat bottom frame 14 is configured to support a seat bottom of a seat. In this manner, the seat adjustment mechanism 10 provides for stowing of the seat relative to an external structure such as a vehicle floor through actuation of a single release mechanism 130 or button 501.

The description of the invention is merely exemplary in nature and, thus, variations that do not depart from the gist of the invention are intended to be within the scope of the invention. Such variations are not to be regarded as a departure from the spirit and scope of the invention.

1. A seat adjustment mechanism for a vehicle seat including a seat bottom supported by the vehicle and a seatback coupled to the seat bottom, said mechanism comprising:
a floor latch mechanism operable between a latched state and an unlatched state, said floor latch mechanism connected to the vehicle seat and operable to pivot the seat bottom relative the vehicle in said unlatched state;
a recliner mechanism operable between a locked state and an unlocked state, said recliner mechanism coupled to the seat bottom and seatback and operable to permit rotation of the seatback relative to the seat bottom in said unlocked state; and
a release mechanism coupled to said floor latch mechanism and operable to selectively toggle said floor latch mechanism into said unlatched state, said recliner mechanism automatically toggled into said unlocked state when said floor latch mechanism is in said unlatched state and the seat bottom is rotated a predetermined amount relative to the vehicle.

2. The seat adjustment mechanism of claim 1, further comprising a tension member operably connected to said recliner mechanism at a first end and operably connected to the vehicle at a second end such that rotation of said recliner mechanism relative to the vehicle places said tension member under tension.

3. The seat adjustment mechanism of claim 2, wherein said tension member is a cable.

4. The seat adjustment mechanism of claim 1, further comprising a headrest assembly disposed at an opposite end of the seatback from said recliner mechanism.

5. The seat adjustment mechanism of claim 4, wherein said headrest assembly is in communication with one of said floor latch mechanism and said recliner mechanism to retract said headrest mechanism prior to said recliner mechanism being toggled into said unlocked state.

6. The seat adjustment mechanism of claim 1, further comprising a four-bar link system operable to allow the seatback and seat bottom to fold flat relative to a floor of the vehicle.

7. The seat adjustment mechanism of claim 1, further comprising a linear recliner mechanism operable to allow the seatback and seat bottom to fold flat relative to a floor of the vehicle.

8. The seat adjustment mechanism of claim 1, further comprising a power system, said power system operable to selectively rotate the seatback and seat bottom relative to the vehicle when said floor latch mechanism is in said unlatched state and said recliner mechanism is in said unlocked state.

9. The seat adjustment mechanism of claim 1, further comprising a system controller, said system controller operable to control said floor latch mechanism between said latched state and said unlatched state.

10. The seat adjustment mechanism of claim 1, further comprising a system controller, said system controller operable to control said recliner mechanism between said locked state and said unlocked state.

11. The seat adjustment mechanism of claim 1, further comprising a sensor associated with said floor latch mechanism and operable to determine whether the floor latch mechanism is in said latched state or said unlatched state.

12. The seat adjustment mechanism of claim 11, further comprising a system controller in communication with said sensor, said system controller operable to control said recliner mechanism based on input from said sensor.

13. The seat adjustment mechanism of claim 1, wherein said recliner mechanism is a powered recliner mechanism.
